(19) United States
(12) Patent Application Publication
(10) Pub. No.: US 2011/0043578 A1
(43) Pub. Date: Feb. 24, 2011

(54) IMAGE FORMING METHOD

(75) Inventor: Kaoru TOJO, Kanagawa (JP)

Correspondence Address: Solaris Intellectual Property Group, PLLC, 401 Holland Lane, Suite 407, Alexandria, VA, 22314, US

(73) Assignee: FUJIFILM CORPORATION, Tokyo (JP)

(21) Appl. No.: 12/830,439

(22) Filed: Jul. 6, 2010

(30) Foreign Application Priority Data
Aug. 24, 2009 (JP) 2009-193676

(51) Int. Cl. B41J 2/01

(52) U.S. Cl. 347/102

(57) ABSTRACT

An image forming method including: at least recording an image by ejecting, by an ink jet method, an ink composition containing, at least one pigment as a coloring material, particles of at least one resin, at least one water-soluble organic solvent, and water, the ink composition having a surface tension of from 30 mN/m to 40 mN/m, to a recording medium having a single-layered or multi-layered pigment layer on or above at least one side of a support containing cellulose pulp as a main ingredient and a transferring amount of pure water to the recording medium, when measured by a dynamic scanning liquid absorptometer, of from 1 ml/m² to 15 ml/m² at a period of contact time of 100 ms and from 2 ml/m² to 20 ml/m² at a period of contact time of 400 ms, and heating the recorded image, is provided.

### CROSS-REFERENCE TO RELATED APPLICATION

This application claims priority under 35 USC 119 from Japanese Patent Application No. 2009-193676, filed on Aug. 24, 2009, the disclosure of which is incorporated by reference herein.

### BACKGROUND OF THE INVENTION

1. Field of the Invention

The present invention relates to an image forming method.

2. Description of the Related Art

An ink jet recording method is a method in which recoding is performed by ejecting liquid ink droplets to a recording medium, and fixing the ink to the recording medium. The ink jet recording method has been mainly used in the fields of office printers, home printers, and the like, and, in recent years, has been gradually applied to a commercial printing field.

Since the ink jet recording method is a technique of ejecting ink at a high speed from a fine nozzle, a low concentration and low viscosity ink is used and the ink amount also increases. In order to address this problem, inkjet papers having an ink absorption layer have been developed. However, these inkjet papers are expensive, so that they are unsuitable for commercial printing in terms of cost.

One example of recording media widely used for commercial printing includes a coated paper whose surface has been coated with pigments in order to mainly improve unevenness of the paper surface. The coated paper is not designed to absorb a large amount of ink in a short time. Thus, when the coated paper is used as an ink jet recording medium, considerable ink bleeding occurs and high resolution images are hard to obtain. The pigments to be used for coating are inexpensive pigments, such as calcium carbonate or kaolin and the hiding properties when ink penetrates are high, and thus, the development of the printed image density becomes weak. In order to apply the ink jet recording method to the commercial printing field, the applicability to the recording media widely used for the commercial printing has been demanded.

Furthermore, in the commercial printing, an increase in the ink jet recording rate has also been demanded. For example, the time required for treatment, such as drying, fixing, or the like, after recording is preferably shorter. However, when the treatment time is shortened, drying of water, organic solvents, or the like contained in ink or penetration thereof into recording media becomes insufficient. Under the condition of an image which is still soft, when a recording medium is piled on the top of the image, blocking in which an image portion transfers to the rear surface of the recording medium is likely to occur. In a recording system in which members, such as a roller, contact images, e.g., images are fixed by subjecting the same to a heating and pressure bonding treatment subsequent to drying treatment, when a sufficient drying time after recording is not secured, an offset phenomenon sometimes occurs in which images transfer to the roller or the like to cause roller stain and image defects.

In order to address the problems, a recording ink specified by the content of solid ingredients in the ink, the content ratio of liquid ingredients/solid ingredients, and the viscosity of the ink and an ink jet recording method using the ink are disclosed (e.g., Japanese Patent Application Laid-Open (JP-A) No. 2008-101192). Moreover, an ink jet recording method including printing images in a given ink adhesion amount to a coated paper specified by the transfer amount of pure water to a medium measured by a dynamic scanning liquid absorptometer, subjecting the images to set-to-touch, and then directly contacting the medium with a heat source to fix them is described (e.g., JP-A No. 2008-100511).

However, according to the ink and the ink jet recording method using the ink described in JP-A No. 2008-101192, a resin forming the solid ingredients in the ink is preferably a resin having a glass transition temperature of 25° C. or lower. When a resin having such a low glass transition temperature is used, the occurrence of blocking or the like cannot be sufficiently suppressed in images after recording.

According to the description of Examples, the surface tension of the ink is low (25.9 mN/m or lower) and particularly when printed to a coated paper, such as a coated paper, a light weight coated paper, or a fine coated paper, ink droplets are likely to be wet and spread, and thus high resolution and high quality images are difficult to form.

According to the ink jet recording method described in JP-A No. 2008-100511, the set-to-touch time needs to secure for several seconds immediately after printing, and is preferably 5 seconds or more and more preferably 15 seconds or more under an environment of 25° C. and 50% after the ink impacts a medium. Therefore, an increase in the ink jet recording rate is limited, and influence on productivity is not small.

According to the description of Examples, the image resolution is 600 dpi and the ink droplet sizes used for printing are 20 pl, 10 pl, and 2 pl, which are far from high definition. Moreover, the surface tension of the ink is low (25 mN/m) and particularly when printed to a coated paper, such as a coated paper, a light weight coated paper, or a fine coated paper, ink droplets are likely to be wet and spread, and thus high resolution and high quality images are difficult to form. In addition, since the solid content in the ink is low, film-quality properties, such as scratch resistance of images after printing, constitutes a matter of concern.

### SUMMARY OF THE INVENTION

An aspect of the present invention for addressing the above-described problems is an image forming method including: at least an image recording process that records an image by ejecting, by an ink jet method, an ink composition containing, at least one pigment as a coloring material, particles of at least one resin, at least one water-soluble organic solvent, and water, the ink composition having a surface tension of from 30 mN/m to 40 mN/m, to a recording medium having a single-layered or multi-layered pigment layer on or above at least one side of a support containing cellulose pulp as a main ingredient of the support and a transferring amount of pure water to the recording medium, when measured by a dynamic scanning liquid absorptometer, of from 1 ml/m² to 15 ml/m² at a period of contact time of 100 ms and from 2 ml/m² to 20 ml/m² at a period of contact time of 400 ms, and a heating process that heats the recorded image.

### BRIEF DESCRIPTION OF THE DRAWINGS

FIG. 1 is a schematic view showing an example of the structure of an ink-jet recording device to be used for carrying out an image forming method of the present invention.

### DETAILED DESCRIPTION OF THE INVENTION

The present invention has been made in order to address the above problems.

Aspects of the present invention are as follows.
<1> An image forming method including: at least an image recording process that records an image by ejecting, by an ink jet method, an ink composition containing, at least one pigment as a coloring material, particles of at least one resin, at least one water-soluble organic solvent, and water, the ink composition having a surface tension of from 30 mN/m to 40 mN/m, to a recording medium having a single-layered or multi-layered pigment layer on or above at least one side of a support containing cellulose pulp as a main ingredient of the support and a transferring amount of pure water to the recording medium, when measured by a dynamic scanning liquid absorptometer, of from 1 ml/m² to 15 ml/m² at a period of contact time of 100 ms and from 2 ml/m² to 20 ml/m² at a period of contact time of 400 ms, and a heating process that heats the recorded image.
<2> The image forming method according to <1>, in which a glass transition temperature of the resin particles is 80° C. or more.

<3> The image forming method according to <1> or <2>, in which the heating process is at least one of a drying process for drying an image in a state where a heat source and the recording medium are not in contact with each other and a fixing process for fixing the image in a state where the heat source and the recording medium are in contact with each other.
<4> The image forming method according to <3>, in which a fixing temperature used in the fixing process is lower than 100° C.
<5> The image forming method according to any one of <1> to <4>, in which the recording medium is a coated paper, a light weight coated paper, or a fine coated paper.
<6> The image forming method according to any one of <1> to <5>, in which the ink composition contains an acetylene glycol surfactant as a surface tension controlling agent.
<7> The image forming method according to any one of <1> to <6>, in which the ink composition contains solid ingredients that are in a solid state in the ink composition of 25° C. and liquid ingredients that have a vapor pressure lower than that of water and are in a liquid state in the ink composition of 25° C., the total content of the solid ingredients in the ink composition is 2.0 mass % or more and lower than 20 mass %, and a ratio (A/B) of the total content (A) of liquid ingredients in the ink composition to the total content (B) of solid ingredients in the ink composition is from 0.70 to 1.75.
<8> The image forming method according to <7>, wherein the ratio A/B is in the range of 1.00 to 1.70.
<9> The image forming method according to <7>, wherein the ratio A/B is in the range of 1.20 to 1.65.
<10> The image forming method according to any one of <1> to <9>, wherein the transfer amount of pure water to the recording medium, when measured by a dynamic scanning liquid absorptometer, of from 1 ml/m² to 10 ml/m² at a period of contact time of 100 ms and from 2 ml/m² to 15 ml/m² at a period of contact time of 400 ms.
<11>The image forming method according to any one of <1> to <9>, wherein the transfer amount of pure water to the recording medium, when measured by a dynamic scanning liquid absorptometer, of from 1 ml/m² to 8 ml/m² at a period of contact time of 100 ms and from 2 ml/m² to 10 ml/m² at a period of contact time of 400 ms.
<12> The image forming method according to any one of <1> to <11>, wherein the pigment is a self-dispersible pigment.
<13> The image forming method according to <12>, wherein the self-dispersible pigment is an anionically charged pigment or a cationically charged pigment.
<14> The image forming method according to <13>, wherein the self-dispersible pigment has an anionic hydrophilic group selected from the group consisting of —COOM, —SO₃M, —PO₃HM, —PO₃M₂, —SO₂NH₂, and —SO₂NHCOR, in which M represents a hydrogen atom, an alkaline metal, ammonium, or organic ammonium; and R represents an alkyl group having 1 to 12 carbon atoms, a phenyl group that may have a substituent, or a naphthyl group that may have a substituent.
<15> The image forming method according to <13>, wherein the self-dispersible pigment has an ammonium group.
<16> The image forming method according to <12>, wherein the self-dispersible pigment is used together with a polymer dispersant.
<17> The image forming method according to <16>, wherein the polymer dispersant has a carboxyl group.
<18> The image forming method according to any one of <1> to <17>, wherein the surface tension of the ink composition is in the range of 32 mN/m to 40 mN/m.
<19> The image forming method according to any one of <1> to <17>, wherein the surface tension of the ink composition is in the range of 32 mN/m to 38 mN/m.
<20> The image forming method according to <4>, wherein a fixing temperature in the fixing is lower than 100° C., and the glass transition temperature of the resin particles in the ink composition is 100° C. or more.

The present invention can provide an image forming method by an ink jet method that can perform high-resolution-full-color printing to commercial printing paper, can record images having excellent printing grade and having favorable blocking resistance, offset resistance, and scratch resistance, and can increase a recording rate.

Hereinafter, embodiments of the image forming method according to the invention will be described in detail.

The image forming method includes at least an image recording process that records an image by ejecting, by an ink jet method, an ink composition containing, at least one pigment as a color material, particles of at least one resin, at least one water-soluble organic solvent, and water, the ink composition having a surface tension of from 30 mN/m to 40 mN/m, to a recording medium having a single or multi-layered pigment layer on or above at least one side of a support containing cellulose pulp as a main ingredient and a transfer amount of pure water to the recording medium, when measured by a dynamic scanning liquid absorptometer, of from 1 ml/m² to 15 ml/m² at a period of contact time of 100 ms and from 2 ml/m² to 20 ml/m² at a period of contact time of 400 ms, and a heating process that heats the recorded image.

In the image forming method, images are recorded onto the recording medium using the ink composition. As a result, a recorded image having not only high resolution, but also excellent water resistance and scratch resistance (also referred to as abrasion resistance) can be obtained.

Moreover, according to the image forming method, by recording an images by combining the recording medium and the ink composition, and then providing a process that heats the image, a recording system in which the recording rate can be further increased by recording using a single path or the like is structured, and even when the time secured for treatment, such as drying or fixing after ejecting, is short, the occurrence of blocking or offset can be effectively prevented.

Image Recording Step

In the image recording step, the ink composition for ink jet recording of the present invention is ejected by an ink-jet method to record an image on a recording medium.

Image recording by utilizing the ink-jet method can be performed by supplying energy to eject an ink composition to a coated paper, whereby a colored image can be formed. As the ink-jet method of the present invention, for example, a method described in paragraphs 0093 to 0105 of JP-A No. 2003-306623 may be used as a preferable method.

The ink-jet method is not particularly limited and may be of any known system, for example, a charge control system of ejecting an ink by utilizing an electrostatic attraction force, a drop on demand system of utilizing a vibration pressure of a piezo element (pressure pulse system), an acoustic ink jet system of converting electric signals into acoustic beams, irradiating them to an ink, and ejecting the ink by utilizing a radiation pressure, and a thermal ink-jet system of heating an ink to form bubbles and utilizing the resultant pressure. As the ink jet method, an ink jet method described in JP-A No. 54-59936 of causing abrupt change in volume of ink upon thermal energy, and ejecting the ink from a nozzle by an operation force arising from the resultant change of state can be utilized effectively.

Examples of the ink jet method include a system of injecting a number of ink droplets of low density, a so-called “photo-ink” each in a small volume, a system of improving an image quality by using plural kinds of inks of a substantially identical hue and of different densities, and a system of using a colorless transparent ink.

In the image recording step, for example, a recording medium-conveying speed may be varied to record an image. The recording medium-conveying speed is not specifically limited as long as the image quality is not impaired. The recording medium-conveying speed is preferably from 100 mm/s to 3000 mm/s, more preferably from 150 mm/s to 2700 mm/s, and still more preferably from 250 mm/s to 2500 mm/s.

Recording Medium

The recording medium used in the invention has a single or multi-layered pigment layer on or above at least one side of a support containing cellulose pulp as a main ingredient and a transfer amount of pure water to the recording medium, when measured by a dynamic scanning liquid absorptometer, of from 1 ml/m² to 15 ml/m² at a period of contact time of 100 ms and from 2 ml/m² to 20 ml/m² at a period of contact time of 400 ms.

Support

As the support containing cellulose pulp as a main ingredient used in the invention, it is possible to use one produced by the method of preparing a raw material by mixing chemical pulps, mechanical pulps, recycled pulps from used paper, and the like in a given ratio, optionally adding thereto an internally-applied sizing agent, a yield improving agent, a paper strength enhancing additive, or the like, and making paper from the raw material by means of a fourdrinier former, a gap -type twin-wire former, or a hybrid former in which a latter part of the fourdrinier former is structured with a twin-wire.

Here, the “a main ingredient” refer to an ingredient contained in a proportion of 50 mass % or more relative to the mass of the support.

The pulps to be used for the support may contain: virgin chemical pulp (CP) obtained by chemically treating wood and other fibrous materials, such as a bleached hardwood kraft pulp, a bleached softwood kraft pulp, an unbleached hard wood kraft pulp, an unbleached soft wood kraft pulp, a bleached hard wood sulfite pulp, a bleached softwood sulfite pulp, an unbleached hardwood sulfite pulp, an unbleached softwood sulfite pulp, and the like; and virgin mechanical pulp (MP) which is obtained by mainly mechanically treating wood and other fibrous materials, such as a ground pulp, a chemi-ground pulp, a chemi-mechanical pulp, a semi-chemical pulp, and the like. The recycle pulp may also be used, and examples of raw materials of the recycle pulp include high white, line white, cream white, card, special white, mild white, imitation, pale, Kent, white art, special high cut, separate high cut, news paper, and magazine shown in Standard Chart of Recycled Paper, produced by Paper Recycling Promotion Center that is Japanese non-profit foundation. Specific examples thereof include paper containing chemical pulps and paper containing high yield pulps that are recycled paper or cardboards, such as: printing paper, such as a non-coated paper for computers, which is paper for information technology, a heat sensitive paper, or a pressure sensitive paper; a recycled OA paper, such as paper for PPC; a coated paper, such as an art paper, a coated paper, a fine coated paper, or a matte paper; or a non-coated paper, such as high quality paper, high quality color paper, paper from note books, paper from letter pads, a lapping paper, a fancy paper, a middle quality paper, a news paper, a bank paper, a lapping paper to be used in supermarkets, an imitation paper, a pure-white rolling paper, or a milk carton. The paper may be used singly or in combination of two or more thereof.

As a filler that can be used in the support, calcium carbonate is effective, and inorganic fillers, such as silica compounds (e.g., kaolin, calcined clay, pyrophylite, sericite, and talc), satin white, barium sulfate, calcium sulfate, or zinc sulfate; or organic pigments, such as plastic pigment, or urea resin can be used in combination.

The internally-applied sizing agent to be used for the support is not particularly limited and can be suitably selected from known internally-applied sizing agents. Examples of suitable internally-applied sizing agents include a rosin emulsion sizing agent. Examples of internally-applied sizing agents to be used for making the support include a neutral rosin sizing agent used for making neutral paper, alkenyl succinic anhydride (ASA), alkyl ketene dimer (AKD), and petroleum resin sizing agent. Among the above, the neutral rosin sizing agent or alkenyl succinic anhydride is particularly preferable. Since the size effect of the alkylketene dimer is high, the added amount thereof may be small. However, since the friction coefficient of the surface of a recording medium decreases and it becomes easy to slide, it may not be preferable from the viewpoint of the conveyance properties during ink-jet recording.

The amount of the internally-applied sizing agent is 0.1 parts by mass to 0.7 parts by mass relative to 100 parts by mass of bone-dry pulp, but is not limited thereto.

Examples of the internally-applied fillers to be used for the support include known pigments as white pigments. Examples of the white pigments include inorganic white pigments, such as light calcium carbonate, heavy calcium carbonate, kaolin, clay, talc, calcium sulfate, barium sulfate, titanium dioxide, zinc oxide, zinc sulfide, zinc carbonate, satin white, aluminum silicate, diatomaceous earth, calcium silicate, magnesium silicate, synthetic silica, aluminum hydroxide, alumina, lithopone, zeolite, magnesium carbonate, or magnesium hydroxide; and organic pigments, such as styrene plastic pigment, acrylic plastic pigment, polyethylene, microcapsule, urea resin, or melamine resin. The fillers may be used singly or in combination of two or more thereof.

Pigment Layer

The recording medium used in the invention has a single or multi-layered pigment layer on or above at least one surface of the support.

The type of the pigment to be used for the pigment layer is not particularly limited, and known organic pigments or inorganic pigments can be used and they can be used singly or as a mixture of two or more thereof.

Examples of the pigment include inorganic white pigments, such as light calcium carbonate, heavy calcium carbonate, kaolin, talc, calcium sulfate, barium sulfate, titanium dioxide, zinc oxide, zinc sulfide, zinc carbonate, satin white, aluminum silicate, diatomaceous earth, calcium silicate, magnesium silicate, synthetic amorphous silica, colloidal silica, colloidal alumina, pseudo boehmite, aluminium hydroxide, aluminum oxide (alumina), lithopone, zeolite, hydrated halloysite, magnesium carbonate, or magnesium hydroxide; and organic pigments, such as styrene plastic pigment, acrylic plastic pigment, polyethylene, microcapsule, urea resin, or melamine resin. From the viewpoint of holding the transparency of a recording medium and increasing the printed image density, the white pigments are preferable.

The pigment layer can further contain additives, such as aqueous binders, antioxidants, surfactants, antifoaming agents, foam inhibitors, pH regulators, curing agents, coloring materials, fluorescent whitening agents, antiseptics, or water resistance imparting agents.

Examples of the aqueous binders include water-soluble polymers, such as a styrene/maleic acid salt copolymer, a styrene/acrylic acid salt copolymer, polyvinyl alcohol, silanol-modified polyvinyl alcohol, starch, cationized starch, casein, gelatin, carboxymethylcellulose, hydroxyethylcellulose, or polyvinyl pyrrolidone and water-dispersible polymers, such as styrene butadiene latex or acryl emulsion.

Methods for forming the pigment layer on a support can be suitably selected without particular limitation according to the purpose. For example, the pigment layer can be formed by applying a dispersion liquid in which pigments have been dispersed in water to a base paper, and drying.

In the invention, the amount of the pigments in the pigment layer is preferably in the range of 0.1 g/m² to 20 g/m² and more preferably in the range of 0.5 g/m² to 10 g/m². When the amount of the pigment is lower than 0.1 g/m², blocking resistance is poor, and when the amount of the pigment is higher than 20 g/m², brittleness increases.

The content of the pigments to be contained in the pigment layer is preferably 10 mass % or more, more preferable 14 mass % or more, and still more preferably 18 mass % or more relative to the total solid content of the layer.

Physical Properties of Recording Medium

The recording medium used in the invention has a transfer amount of pure water to the recording medium of from 1 ml/m² to 15 ml/m² at a contact time of 100 ms and from 2 ml/m² to 20 ml/m² at a contact time of 400 ms, the transfer amount being measured by a dynamic scanning liquid absorptometer.

In the image forming method of the invention, recorded images having high resolution and excellent water resistance and scratch resistance can be obtained using a recording medium having such a relatively small ink absorption amount as the above-mentioned range of the transfer amount. In other words, according to the image forming method of the invention, even when a recording medium (e.g., inkjet paper) that shows a transfer amount beyond the range of the transfer amount mentioned above whereby the recording medium can absorb a large amount of ink is not used, recorded images having a high resolution and excellent water resistance and scratch resistance can be obtained by an ink jet method.

With respect to the transfer amount, “1 ml/m² or more at a contact time of 100 ms and 2 ml/m² or more at a contact time of 400 ms” indicates that the recording medium has a pigment layer capable of absorbing ink.

Here, the dynamic scanning absorptometer (DSA, JAPAN TAPPI JOURNAL, Vol. 48, May 1994, pp. 88-92, Shigenori Kuga) is a device capable of correctly measuring the liquid absorption amount in an extremely short time. In the dynamic scanning absorptometer, the measurement is automated by a method including directly reading the liquid absorption rate from the movement of the meniscus in a capillary, scanning a liquid absorbing head in a spiral manner on a sample that is formed into a disk, automatically changing the scanning rate according to a predetermined pattern, and measuring only a required number of points by one sheet sample. A liquid supply head to a paper sample is connected to the capillary through a Teflon (registered trademark) pipe, and the position of the meniscus in the capillary is automatically read by an optical sensor. Specifically, the transfer amount of pure water or ink was measured using a dynamic scanning absorptometer (K350 series D type, manufactured by Kyowa Seiko Co., Ltd.). The transfer amount at a contact time of 100 ms and the transfer amount at a contact time of 400 ms can be determined by interpolating measurement values of the transfer amount at a contact time near the respective contact times. The measurement was performed at 23° C. and 50% RH.

In the recording medium used in the invention, the transfer amount of pure water to the recording medium at a contact time of 100 ms measured by the dynamic scanning absorptometer is 1 ml/m² to 15 ml/m², more preferably 1 ml/m² to 10 ml/m², and still more preferably 1 ml/m² to 8 ml/m². When the transfer amount of pure water at a contact time of 100 ms is excessively small, beading is likely to occur in some cases and while when the transfer amount of pure water at a contact time of 100 ms is excessively large, the ink dot diameter after recording becomes much smaller than a desired diameter in some cases.

The beading refers to a phenomenon that occurs when some ink droplets impacted onto a recording medium during inkjet recording do not completely infiltrate in the recording medium before the next ink droplets are impacted and remain and are mixed with subsequent ink droplets on the recording medium surface, whereby colorants in the ink partly aggregate, which results in causing uneven densities.

In the recording medium used in the invention, the transfer amount of pure water to the recording medium at a contact time of 400 ms measured by the dynamic scanning absorptometer is 2 ml/m² to 20 ml/m², more preferably 2 ml/m² to 15 ml/m², and still more preferably 2 ml/m² to 10 ml/m². When the transfer amount at a contact time of 400 ms is excessively small, drying properties are insufficient, and thus spur marks are likely to occur and while when the transfer amount at a contact time of 400 ms is excessively large, bleeding is likely to occur and the glossiness of an image portion after drying is likely to decrease.

The pigment layer of the recording medium used in the invention has a composition containing a pigment and a resin binder as a main ingredient. The transfer amount can be adjusted to decrease by increasing the resin amount and the transfer amount can be adjusted to increase by increasing the pigment amount. Moreover, the transfer amount can also be increased by increasing the specific surface area of pigment particles constituting the pigment layer, e.g., reducing the particle size or using a pigment having a large specific surface area.

As a recording medium used in the invention, for example, a coated paper, which is used in general offset printing or the like, may be used. The coated paper is a product obtained by applying a coating material on the surface of a high quality paper, a neutral paper or the like, which is mainly made of cellulose and is generally not surface-treated, to provide a coating layer.

In general, conventional aqueous ink jet image formation using a coated paper as a recording medium is likely to cause problems in the product quality, such as bleeding of image or scratch resistance, but in the image forming method of the invention, the image bleeding may be suppressed, and the generation of density unevenness may be prevented so that images with density uniformity can be formed, and images having a high resolution and good scratch resistance may be recorded.

According to the image forming method of the invention, a coated paper, a light weight coated paper, or a fine coated paper can be suitably used, and high grade images can be effectively formed on the recording media.

As the coated paper, generally marketed paper can be obtained and used. For example, a coated paper for general printing can be used. Specific examples of the recording medium include A2 gross paper, such as “OK TOP COAT+” (trade name, manufactured by Oji Paper), “AURORA COAT” (trade name, manufactured by Nippon Paper Group), “PEARL COAT” (trade name, manufactured by Mitsubishi Paper Mills Ltd.), “S UTRILLO COAT” (trade name, manufactured by Daio Paper Corporation), “MYU COAT NEOS” (trade name, manufactured by Hokuetsu Paper Mills), or “RAICHO COAT” (trade name, manufactured by Chuetsu Pulp and Paper Co., Ltd.), A2 matte paper, such as “NEW AGE” (trade name, manufactured by Oji Paper), “OK TOPCOAT MATTE” (trade name, manufactured by Oji Paper), “U-LIGHT” (manufactured by Nippon Paper Industries), “NEW V MATTE” (trade name, manufactured by Mitsubishi Paper Mills Ltd.), or “RAICHO MATTE COAT N” (trade name, manufactured by Chuetsu Pulp and Paper Co., Ltd.), A1 gross art paper, such as “OK KINFUJI+” (trade name, manufactured by Oji Paper), “TOKUBISHI ART” (trade name, manufactured by Mitsubishi Paper Mills Ltd.), or “RAICHO-TOKU ART” (trade name, manufactured by Chuetsu Pulp and Paper Co., Ltd.), A1 dull art paper, such as “SATIN KINFUJI+” (trade name, manufactured by Oji Paper), “SUPER MATTE ART” (trade name, manufactured by Mitsubishi Paper Mills Ltd.), or “RAICHO DULL ART” (trade name, manufactured by Chuetsu Pulp and Paper Co., Ltd.), and A0 art paper, such as “SA KINFUJI+” (trade name, manufactured by Oji Paper), “HIGH-CLASS ART” (trade name, manufactured by Mitsubishi Paper Mills Ltd.), “RAICHO SUPER ART N” (trade name, manufactured by Chuetsu Pulp and Paper Co., Ltd.), “ULTRA SATIN KINFUJI+” (trade name, manufactured by Oji Paper), or “DIAPREMIER DULL ART” (trade name, manufactured by Mitsubishi Paper Mills Ltd.).

Ink Composition

The ink composition used in the invention contains at least one pigment as a color material, at least one kind of resin particles, at least one water-soluble organic solvent, and water and has a surface tension of from 30 mN/m to 40 mN/m.

The ink composition is used as an ink-jet recording ink, and can be used for recording color images. For example, when full color images are formed, it is preferable to use the ink composition as a magenta color tone ink, a cyan color tone ink, and a yellow color tone ink, and in order to adjust the color tone, the ink composition may be used as a black color tone ink. Moreover, the ink composition can be used, for example, as a red, green, blue, or white ink, or as a so-called special-color ink in the field of printing, other than the yellow, magenta, and cyan color tone inks.

Pigment

The ink composition used in the invention includes at least one pigment as a color material. The pigment can be suitably selected without particular limitation according to the purpose and, for example, may be any of inorganic pigments and organic pigments.

Examples of the inorganic pigments include titanium oxide, iron oxide, calcium carbonate, barium sulfate, aluminum hydroxide, barium yellow, cadmium red, chrome yellow, carbon black, Prussian blue, and metal powder. Among the above, carbon black and the like are preferable. Examples of the carbon black include one manufactured by known methods, such as a contact method, a furnace method, or a thermal method.

Examples of the organic pigments include an azo pigment, a polycyclic pigment, a dye chelate, a nitro pigment, a nitroso pigment, and aniline black. Among the above, an azo pigment, a polycyclic pigment, and the like are more preferable. Examples of the azo pigment include an azo rake, an insoluble azo pigment, a condensed azo pigment, and a chelate azo pigment. Examples of the polycyclic pigment include a phthalocyanine pigment, a perylene pigment, a perynone pigment, an anthraquinone pigment, a quinacridone pigment, a dioxazine pigment, an indigo pigment, a thioindigo pigment, an isoindolinone pigment, a quinophralone pigment, an azomethine pigment, and a rhodamine B lake pigment. Examples of the dye chelate include a basic dye type chelate and an acid dye type chelate.

The color of the pigment can be suitably selected without particular limitation according to the purpose and examples of the pigment include a pigment for black and a pigment for color. The pigment may be used singly or in combination of two or more thereof.

As the pigment, self-dispersible pigments that can be stably dispersed without using a dispersant in which at least one hydrophilic group is bonded to the pigment surface directly or through another atom group are preferably used. As a result, a dispersant necessary for dispersing the pigment in a conventional ink becomes unnecessary. As the self-dispersible pigments, ionic pigments are preferable, and anionically charged pigments or cationically charged pigments are preferable.

The volume average particle diameter of the self-dispersible pigment is preferably 0.01 to 0.16 μm in ink.

Examples of the anionic hydrophilic group include —COOM, —SO₃M, —PO₃HM, —PO₃M₂, —SO₂NH₂, and —SO₂NHCOR, in which M represents a hydrogen atom, an alkaline metal, ammonium, or organic ammonium; and R represents an alkyl group having 1 to 12 carbon atoms, a phenyl group that may have a substituent, or a naphthyl group that may have a substituent. Among the above, a color pigment having —COOM or —SO3M bonded to the surface of the color pigment is preferably used.

In the hydrophilic group, examples of “M” include, as an alkaline metal, lithium, sodium, and potassium. Examples of the organic ammonium include mono- to tri-methyl ammonium, mono- to tri-ethyl ammonium, and mono- to tri-methanol ammonium. Among methods of obtaining anionically charged color pigments, examples of a method of introducing —COONa into the color pigment surface include a method of subjecting the color pigment to oxidation treatment using sodium hypochlorite, a method of subjecting the color pigment to sulfonation, or a method of reacting the color pigment and a diazonium salt.

As the cationic hydrophilic group, quaternary ammonium groups are preferable, for example, and the following quaternary ammonium groups are more preferable. Pigments to the surface of which any of the quaternary ammonium groups is bonded are preferable as a coloring material.

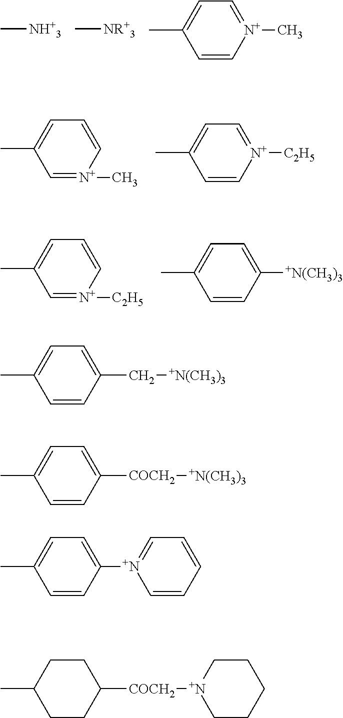

Examples of the method of manufacturing the cationic self-dispersible carbon black to which the hydrophilic group is bonded include a method in which an N-ethyl pyridyl group represented by the following structural formula is bonded to carbon black, such as a method in which carbon black is treated with a 3-amino N-ethyl pyridium bromide. It is a matter of course that the invention is not limited thereto.

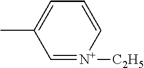

In the invention, the hydrophilic group may be bonded to the surface of carbon black through another atom group. Examples of the another atom group include an alkyl group having 1 to 12 carbon atoms, a phenyl group that may have a substituent, and a naphthyl group that may have a substituent. Specific examples of the case where the hydrophilic group is bonded to the surface of carbon black through another atom group include —C₂H₄COOM (M represents an alkaline metal or quaternary ammonium), -PhSO₃M (Ph represents a phenyl group and M represents an alkaline metal or quaternary ammonium), and —C₅H₁₀NH₃⁺.

In the invention, a pigment dispersion liquid prepared using a pigment dispersant can also be used.

Examples of the pigment dispersant as the hydrophilic polymer compound include the following natural polymers, semi-synthetic polymers and pure-synthetic polymers. Examples of the natural polymers include plant polymers, such as gum arabic, tragacanth gum, guar gum, karaya gum, locust bean gum, arabinogalactan, pectin, or quince seed starch; seaweed polymers, such as alginic acid, carrageenan, or agar; animal polymers, such as gelatin, casein, albumin, collagen, or shellac; and microbial polymers, such as xanthane gum or dextran. Examples of the semi-synthetic polymers include cellulose polymers, such as methyl cellulose, ethyl cellulose, hydroxyethyl cellulose, hydroxypropyl cellulose, or carboxymethyl cellulose; starch polymers, such as sodium glycolate starch or sodium starch phosphate; and seaweed polymers, such as sodium alginate or propylene glycol ester of alginic acid. Examples of pure-synthetic polymers include vinyl polymers, such as polyvinyl alcohol, polyvinyl pyrrolidone, or polyvinyl methylether; acrylic resins, such as non-crosslinked polyacrylamides, polyacrylic acids or alkali metal salts thereof, or water-soluble styrene acrylic resins; polymer compounds having salts of cationic functional groups at side chains thereof, such as water-soluble styrene maleic acid resins, water-soluble vinylnaphthalene acrylic resins, water-soluble vinylnaphthalene maleic acid resins, polyvinyl pyrrolidone, polyvinyl alcohol, alkali metal salts of β-naphthalene sulfonic acid formalin condensates, and polymer compounds having a salt of a cationic functional group such as a quaternary ammonium group or an amino group at the side chain thereof. Among the above, a polymer compound into which a carboxyl group has been introduced, such as a homopolymer of an acrylic acid, a methacrylic acid, or a styrene acrylic acid, or a copolymer of a acrylic acid, a methacrylic acid, or a styrene acrylic acid and a monomer having a hydrophilic group other than a acrylic acid, a methacrylic acid and a styrene acrylic acid is particularly preferable as the polymer dispersant.

The weight average molecular weight of the copolymer is preferably 3,000 to 50,000, more preferably 5,000 to 30,000, and still more preferably 7,000 to 15,000. The mass mixing ratio of the pigment to the dispersant is preferably in the range of 1:0.06 to 1:3 and more preferably in the range of 1:0.125 to 1:3.

The simultaneous use of the polymer dispersant and the self-dispersible pigment is preferable combination because a suitable dot diameter can be obtained. The reasons are unknown, but are assumed as follows.

By blending the polymer dispersant in an ink, penetration of the ink into a recording paper is suppressed. In contrast, by blending the polymer dispersant in the ink, aggregation of the self-dispersible pigment is suppressed, and thus the self-dispersible pigment can smoothly spread in a transverse direction. Therefore, it is considered that dots thinly and widely spread and ideal dots can be formed.

Moreover, dispersibility can be imparted to pigments by covering the pigments with a resin having a hydrophilic group to microencapsulate the same.

As a microencapsulating method in which a water-insoluble pigment is covered with an organic polymer, any known methods can be used. Examples of the known methods include a chemically manufacturing method, a physically manufacturing method, a physically and chemically manufacturing method, and a mechanically manufacturing method. Specific examples include an interfacial polymerization method, an in-situ polymerization method, an in-liquid curing coating method, a coacervation (phase separation) method, an in-liquid drying method, a dissolution-dispersion-cooling method, an in-gas suspension covering method, a spray drying method, an acid deposition method, and a phase inversion emulsification method described in paragraph 0085 of JP-A No. 2008-100511.

Examples of organic polymers (resin) to be used as materials for constituting a wall film substance of a microcapsule include polyamide, polyurethane, polyester, polyurea, epoxy resin, polycarbonate, urea resin, melamine resin, phenol resin, polysaccharide, gelatin, gum arabic, dextran, casein, protein, crude rubber, carboxy polymethylene, polyvinyl alcohol, polyvinyl pyrrolidone, polyvinyl acetate, polyvinyl chloride, polyvinylidene chloride, cellulose, ethylcellulose, methylcellulose, nitrocellulose, hydroxyethylcellulose, cellulose acetate, polyethylene, polystyrene, a polymer or copolymer of (meth)acrylic acid, a polymer or copolymer of of (meth)acrylic acid ester, a (meth)acrylic acid-(meth)acrylic acid ester copolymer, a styrene-(meth)acrylic acid copolymer, a styrene-maleic acid copolymer, alginic acid soda, fatty acid, paraffin, yellow beeswax, water wax, hardened beef tallow, Carnauba Wax, and albumin.

Among the above, organic polymers having anionic groups, such as a carboxylic acid group or a sulfonic acid group, can be used. Examples of nonionic organic polymers include polyvinyl alcohol, polyethylene glycol monomethacrylate, polypropylene glycol monomethacrylate, methoxy polyethylene glycol monomethacrylate or a copolymer thereof, and a cationic ring-opening polymer of 2-oxazoline. In particular, a completely saponified polyvinyl alcohol has low solubility in water and is likely to dissolve in hot water but is hard to dissolve in cold water, and thus is particularly preferable.

The amount of the organic polymers constituting the wall film substance of a microcapsule is from 1 mass % to 20 mass % relative to water-insoluble coloring materials, such as organic pigments or carbon black. By adjusting the amount of the organic polymers in the above-described range, the content of the organic polymers in the capsule becomes relatively low. As a result, it becomes possible to suppress a reduction in coloring properties of the pigment arising from the organic polymers with which the pigment surface is covered. When the amount of the organic polymers is lower than 1 mass %, it becomes difficult to exhibit the effects obtained by encapsulation. In contrast, when the amount exceeds 20 mass %, the coloring property of the pigment is considerably decreased. Furthermore, considering other properties, the amount of the organic polymers is preferably in the range of 5 to 10 mass % relative to the water-insoluble coloring materials.

More specifically, since a part of the coloring materials is not completely covered and is substantially exposed, a reduction in the coloring properties can be suppressed. In contrast, since a part of the coloring materials is not exposed and is substantially covered, the benefits brought about by the covered pigment can be enjoyed at the same time. The number average molecular weight of the organic polymers to be used in the invention is preferably 2000 or more, for example, from the viewpoint of manufacturing of capsules. Here, “substantially exposed” does not mean that a part of the coloring material is exposed as a result of defects, such as pinholes or cracks, but means that a part of the coloring material is intentionally exposed.

Furthermore, when the organic pigment which is a self-dispersible pigment or self-dispersible carbon black is used as the coloring material, the dispersibility of the pigment increases even when the content of the organic polymers in a capsule is relatively low, and thus it becomes possible to secure sufficient ink storage stability, which is more preferable for the invention.

Depending on a microencapsulating method, it is preferable to select organic polymers suitable for the microencapsulating method. For example, in the case of the interfacial polymerization method, polyester, polyamide, polyurethane, polyvinyl pyrrolidone, and epoxy resins are preferable. In the case of the in-situ polymerization method, a polymer or copolymer of (meth) acrylic acid ester, a (meth) acrylic acid-(meth) acrylic acid ester copolymer, a styrene-(meth) acrylic acid copolymer, polyvinyl chloride, polyvinylidene chloride, polyamide, and the like are preferable. In the case of the in-liquid curing method, sodium alginate, polyvinyl alcohol, gelatin, albumin, epoxy resins, and the like are preferable. In the case of the coacervation method, gelatin, celluloses, casein, and the like are preferable. In order to obtain fine and uniform microencapsulated pigments, it is a matter of course that any known encapsulating methods in addition to the above-described methods can be used.

When the phase inversion method or the acid deposition method is selected as the microencapsulating method, anionic organic polymers are used as organic polymers constituting the wall film substance of a microcapsule. The phase inversion method includes: preparing an organic solvent phase including a complex or a composite of an anionic organic polymer having self-dispersion ability or dissolution ability in water and a coloring material, such as a self-dispersible organic pigment or self-dispersible carbon black; or a mixture of a coloring material, such as a self-dispersible organic pigment or self-dispersible carbon black, a curing agent and an anionic organic polymer, and then adding water to the organic solvent phase, or pouring the organic solvent phase in water, thereby encapsulating the coloring material with the anionic organic polymer while self-dispersing them (phase inversion emulsification). In the phase dispersion method, microcapsules may be manufactured by mixing vehicles or additives for a recording liquid in the organic solvent phase. In particular, from the viewpoint that a dispersion liquid for a recording liquid can be directly manufactured, it is more preferable to mix a liquid medium of a recording liquid in the organic solvent phase.

Further, the acid deposition method is a microencapsulating method in which firstly a hydrous cake is prepared by a manufacturing method including: neutralizing a part or all of an anionic group of an anionic group-containing organic polymer with a basic compound, and then kneading the resultant anionic group-containing organic polymer with a coloring material, such as a self-dispersible organic pigment or self-dispersible carbon black in an aqueous medium, and then changing the pH to a neutral or acidic region with an acidic compound to deposit the anionic group-containing organic polymer, and then adhering the anionic group-containing organic polymer onto the coloring material; and then a part or all of the anionic group of the hydrous cake is neutralized with a basic compound. Thus, an aqueous dispersion liquid containing a fine anionic microencapsulated pigment containing many pigments can be manufactured.

Examples of a solvent to be used in the microencapsulating method as described above include alkyl alcohols, such as methanol, ethanol, propanol, or butanol; aromatic hydrocarbons, such as benzol, toluol, or xylol; esters, such as methyl acetate, ethyl acetate, or butyl acetate; chlorinated hydrocarbons, such as chloroform or ethylene dichloride; ketones, such as acetone or methyl isobutyl ketone; ethers, such as tetrahydrofuran or dioxane; and cellosolves, such as methyl cellosolve or butyl cellosolve. The microcapsule prepared by the method described above is once separated from the solvent by centrifugal separation or filtration, and then and re-dispersed with water and a required solvent while stirring, thereby obtaining a target recording liquid that can be used in the invention. The average particle diameter of the encapsulated pigment obtained by the method described above is preferably 50 nm to 180 nm.

The added amount of the coloring agent in the ink is preferably 2 to 15 mass % and more preferably 3 to 12 mass %. If the added amount is lower than 2 mass %, reduction of image concentration may be caused by lowering of a coloring strength, or feathering or bleeding may be increase due to reduction in viscosity. If the added amount exceeds 15 mass %, for example, when an inkjet recording device is left, a non-ejection phenomenon may occur due to a nozzle that becomes easy to dry, or the image concentration may decrease or a coarse image may be formed due to reduction in penetration properties arising from highly increased viscosity, or non-spread of dots.

Resin Particles

The ink composition used in the invention contains at least one kind of resin particles.

The resin particles are not particularly limited. Examples of the resin particles include resin particles containing, as a component thereof, a resin such as a thermoplastic acrylic, epoxy, polyurethane, polyether, polyamide, unsaturated polyester, phenol, silicone, or fluorine resin; a polyvinyl resin such as vinyl chloride, vinyl acetate, polyvinyl alcohol, or polyvinyl butyral; a polyester resin such as an alkyd resin or a phthalic acid resin; a copolymer or mixture thereof.

In the invention, it is preferable for the resin particles to have a glass transition temperature (Tg) of 80° C. or higher. By blending resin particles having a Tg of 80° C. or higher, the fixability of the ink composition to a recording medium and the blocking resistance, offset resistance, and scratch resistance of images can be effectively increased. It is preferable for the resin particles to have a function of fixing the ink composition, i.e., an image, by increasing the viscosity of ink by aggregating or destabilizing dispersion when contacting a treating liquid described later or a paper region on which the treating liquid is dried. Such resin particles are preferably dispersed in at least one of water or an organic solvent.

In the invention, a fixing temperature in a fixing process described later is preferably adjusted to be lower than 100° C. In this case, the Tg of the resin particles is preferably 100° C. or higher and more preferably 130° C. or higher. In the fixing process, fixing can be achieved at a heating temperature lower than the Tg measured in the resin particles solely due to a plasticizing effect of the water-soluble organic solvent that is co-exist with the resin particles in the ink composition. By combining the Tg and the fixing temperature of the resin particles as described above, the offset resistance and the blocking resistance become excellent, and an image formation rate can be increased.

The Tg of the resin particles (polymer particles) can be controlled as appropriate by generally used methods. For example, the Tg of the resin particles can be controlled in a suitable range by selecting, as appropriate, the type of a polymerizable group of monomers constituting resin, the type or proportion of substituents on the monomers, the molecular weight of polymer molecules constituting the resin particles.

As the Tg, a measured Tg obtained by the actual measurement is applied. Specifically, the measured Tg refers to a value measured under usual measurement conditions using a differential scanning calorimeter (DSC) EXSTAR6220 (trade name) manufactured by SII Nanotechnology Inc. When the measurement is difficult due to decomposition of resin or the like, a calculated Tg obtained by the following equation is applied. The calculated Tg is obtained by the Equation (1).

1/Tg=Σ(Xᵢ/Tgᵢ) (1)

Here, a polymer as a calculation target is assumed that n types of monomer ingredients from i=1 to n have been copolymerized. Xᵢ represents the weight percent of the i^{th} monomer (ΣXᵢ=1) and Tgᵢ represents the glass transition temperature (absolute temperature) of a homopolymer of the i^{th} monomer. Σ stands for the sum of i=1 to n. For the value of the glass transition temperature of the homopolymer of each monomer (Tgᵢ), a value specified by Polymer Handbook (3rd Edition) (Edited by J. Brandrup and E. H. Immergut) (Wiley-Interscience, 1989)) is employed.

As the resin particles, particles of a self-dispersing polymer are preferred and self-dispersing polymer particles having a carboxyl group are more preferred, from a view point of the ejection stability and the liquid stability (particularly, dispersion stability) in a case of using the pigment. The particles of a self-dispersing polymer (hereinafter, may be referred to as self-dispersing polymer particles) mean particles of a water-insoluble polymer which can form a dispersed state in an aqueous medium by means of a functional group (particularly, an acidic group or a salt thereof) included in the polymer per se in the absence of an additional surfactant, and are water-insoluble polymer particles which do not contain an additional separate emulsifier.

Further, when the self-dispersing polymer is used, delaying in aggregation caused by the separate dispersant may be less likely to occur. Therefore, using the self-dispersing polymer is preferable from the viewpoint of aggregating properties, and is also preferable since a high resolution image may be formed when high speed recording is employed.

The meaning of “dispersed state” includes an emulsified state where the water-insoluble polymer is dispersed in a liquid state in an aqueous medium (emulsion) and a dispersed state where the water-insoluble polymer is dispersed in a solid state in the aqueous medium (suspension).

The water-insoluble polymer used in the invention is preferably such a water-insoluble polymer that can form a dispersed state where the water-insoluble polymer is dispersed in a solid state, from a view point of the aggregation speed and the fixing property when it is used in a liquid composition.

The dispersed state of the self-dispersing polymer particles means such a state where stable presence of a dispersed state can be confirmed visually at 25° C. for at least one week after processes: mixing and stirring a solution in which 30 g of a water-insoluble polymer is dissolved into 70 g of an organic solvent (for example, methyl ethyl ketone), a neutralizing agent capable of neutralizing a salt-forming group of the water-insoluble polymer to 100% (sodium hydroxide when the salt forming group is anionic or acetic acid when the group is cationic), and 200 g of water to prepare a liquid mixture (apparatus: a stirrer equipped with a stirring blade, number of rotation: 200 rpm, 30 min, 25° C.), and then removing the organic solvent from the liquid mixture.

The water-insoluble polymer means a polymer which is dissolved in an amount (amount of dissolution) of 10 g or less when the polymer is dried at 105° C. for 2 hours and then dissolved in 100 g of water at 25° C. The amount of dissolution is, preferably, 5 g or less and, more preferably, 1 g or less. The amount of dissolution is the amount of dissolution when the polymer is neutralized to 100% with sodium hydroxide or acetic acid in accordance with the kind of the salt-forming group of the water-insoluble polymer.

The aqueous medium contains water and may optionally contain a hydrophilic organic solvent. In the invention, the aqueous medium preferably includes water and the hydrophilic organic solvent in an amount of 0.2% by mass or less relative to water and, more preferably, the aqueous medium consists of water.

The main chain skeleton of the resin used in the resin particles in the invention is not particularly limited and, for example, a vinyl polymer or a condensation type polymer (epoxy resin, polyester, polyurethane, polyamide, cellulose, polyether, polyurea, polyimide, polycarbonate, etc.) can be used. Among them, a vinyl polymer is particularly preferred. From the viewpoint of dispersion stability of the resin particles, (meth) acrylic resin particles are more preferred.

(Meth) acrylic resin means methacrylic resin or acrylic resin.

Preferred examples of the vinyl polymer and the monomer used for the vinyl polymer include those described in JP-A Nos. 2001-181549 and 2002-88294. Further, vinyl polymers introduced with a dissociative group to a terminal end of a polymer chain by radical polymerization of a vinyl monomer using a chain transfer agent, a polymerization initiator, or an iniferter having a dissociative group (or a substituent that can be induced to the dissociative group) or by ionic polymerization using a compound having a dissociative group (or substituent that can be induced to the dissociative group) introduced to an initiator or a terminator can also be used.

Preferred examples of condensation type polymers and monomers used for the condensation type polymers include those described in JP-A No. 2001-247787.

The self-dispersing polymer particles in the invention preferably contain a water-insoluble polymer containing a hydrophilic constituent unit and, as a hydrophobic constituent unit, at least one constituent unit derived from an alicyclic monomer, from a viewpoint of the self-dispersibility. In addition to these, the water-insoluble polymer may further include a constituent unit derived from an aromatic group-containing monomer.

The hydrophilic constituent unit is not particularly limited so long as it is derived from a hydrophilic group-containing monomer and it may be either a unit derived from one kind of hydrophilic group-containing monomer or a unit derived from two or more kinds of hydrophilic group-containing monomers. The hydrophilic group is not particularly limited and it may be either a dissociative group or a nonionic hydrophilic group.

The hydrophilic group is preferably a dissociative group from a view point of promoting the self-dispersibility and a view point of stability of the formed emulsified or dispersed state and, more preferably, an anionic dissociative group. Examples of the dissociative group include a carboxyl group, a phosphoric acid group, and a sulfonic acid group and, among them, the carboxyl group is preferred from a viewpoint of the fixing property when the ink composition is ejected onto a recording medium.

The hydrophilic group-containing monomer in the invention is preferably a dissociative group-containing monomer and, preferably, a dissociative group-containing monomer having a dissociative group and an ethylenically unsaturated bond from a viewpoint of the self-dispersibility and the aggregation property.

Examples of the dissociative group-containing monomer include an unsaturated carboxylic acid monomer, an unsaturated sulfonic acid monomer, and an unsaturated phosphoric acid monomer.

Specific examples of the unsaturated carboxylic acid monomer include acrylic acid, methacrylic acid, crotonic acid, itaconic acid, maleic acid, fumaric acid, citraconic acid, and 2-methacryloyloxy methyl succinic acid. Specific examples of the unsaturated sulfonic acid monomer include styrene sulfonic acid, 2-acrylamide-2-methylpropane sulfonic acid, 3-sulfopropyl (meth) acrylate, and bis(3-sulfopropyl)-itaconic acid ester. Specific examples of the unsaturated phosphoric acid monomer include vinyl phosphonic acid, vinyl phosphate, bis(methacryloyloxyethyl) phosphate, diphenyl-2-acryloyloxyethyl phosphate, diphenyl-2-methacryloyloxyethyl phosphate, and dibutyl-2-acryloyloxyethyl phosphate.

Among the dissociative group-containing monomers, the unsaturated carboxylic acid monomer is preferred and, at least one of acrylic acid or methacrylic acid is more preferred from a viewpoint of the dispersion stability and the ejection stability.

Examples of monomers having a nonionic hydrophilic group include: ethylenically unsaturated monomers containing a (poly)ethyleneoxy group or a polypropyleneoxy group, such as 2-methoxy ethyl acrylate, 2-(2-methoxyethoxy)ethyl acrylate, 2-(2-methoxyethoxy)ethyl methacrylate, ethoxytriethylene glycol methacrylate, methoxypolyethylene glycol (molecular weight of from 200 to 1,000) monomethacrylate, or polyethylene glycol (molecular weight of from 200 to 1,000) monomethacrylate; and ethylenically unsaturated monomers containing a hydroxyl group, such as hydroxymethyl(meth)acrylate, 2-hydroxyethyl(meth)acrylate, 2-hydroxypropyl(meth)acrylate, 4-hydroxybutyl(meth)acrylate, hydroxypentyl(meth)acrylate, or hydroxyhexyl(meth)acrylate.

The monomers containing a nonionic hydrophilic group are more preferably an ethylenically unsaturated monomer having alkyl ether at a terminal than an ethylenically unsaturated monomer having a hydroxyl group at a terminal from the viewpoint of the stability of the particles and the content of water-soluble components.

With respect to the hydrophilic constituent unit in the invention, preferable examples of the hydrophilic constituent unit used in the invention include those containing only a hydrophilic unit containing an anionic dissociative group and those containing both a hydrophilic constituent unit containing an anionic dissociative group and a hydrophilic constituent unit containing a nonionic hydrophilic group.

Preferable examples of the hydrophilic constituent unit further include those containing two or more kinds of hydrophilic units each containing an anionic dissociative group, and those containing two or more kinds of hydrophilic constituent units including one or more kinds of hydrophilic constituent units each containing an anionic dissociative group and one or more kinds of hydrophilic constituent units each containing a nonionic hydrophilic group in combination.

The content of the hydrophilic constituent units in the self-dispersing polymer is preferably 25% by mass or lower, more preferably from 1% by mass to 25% by mass, still more preferably from 2% by mass to 23% by mass, and particularly preferably from 4% by mass to 20% by mass, from the viewpoint of viscosity and stability over time of the ink composition.

When two or more kinds of hydrophilic constituent units are contained, the total content of the hydrophilic constituent units is preferably in the range mentioned above.

The content of the constituent unit containing an anionic dissociative group in the self-dispersing polymer is preferably in a range by which the acid value is in a preferable range described below.

The content of the constituent unit having a nonionic hydrophilic group is preferably from 0 to 25% by mass, more preferably from 0 to 20% by mass, and particularly preferably from 0 to 15% by mass from the viewpoint of ejection stability and stability over time.

The self-dispersing polymer particles in the invention preferably contain a polymer containing a carboxyl group and more preferably contain a polymer containing a carboxyl group and having an acid value (mg KOH/g) of from 25 to 100, from the viewpoint of self-dispersibility and an aggregation rate when a treatment liquid described below contacts the self-dispersing polymer particles at the time of recording with the treatment liquid. Furthermore, the acid value is more preferably from 25 to 80 and particularly preferably from 30 to 65 from the viewpoint of self-dispersibility and an aggregation rate when the treatment liquid contacts the self-dispersing polymer particles.

In particular, when the acid value is 25 or more, the stability of self-dispersibility becomes favorable and when the acid value is 100 or lower, aggregation properties increase.

The alicyclic monomer is not particularly limited insofar as it is a compound containing an alicyclic hydrocarbon group and a polymerizable group, and is preferably alicyclic (meth)acrylate from the viewpoint of dispersion stability.

The alicyclic (meth)acrylate has a structural portion derived from (meth)acrylic acid and a structural portion derived from alcohol, and the structural portion derived from alcohol contains at least one unsubstituted or substituted alicyclic hydrocarbon group. The alicyclic hydrocarbon group may be the structural portion derived from alcohol itself or may be bonded to the structural portion derived from alcohol via a linking group.

The “alicyclic (meth)acrylate” refers to methacrylate or acrylate having an alicyclic hydrocarbon group.

The alicyclic hydrocarbon group is not particularly limited insofar as it contains a cyclic non-aromatic hydrocarbon group. Examples thereof include a monocyclic hydrocarbon group, a bicyclic hydrocarbon group, and a polycyclic hydrocarbon group of tri- or higher cycle.

Examples of the alicyclic hydrocarbon group include cycloalkyl groups, such as a cyclopentyl group or a cyclohexyl group, a cyclo alkenyl group, a bicyclo hexyl group, a norbornyl group, an isobornyl group, a dicyclopentanil group, a dicyclopentenyl group, an adamanthyl group, a decahydronaphthalenyl group, a perhydro fluorenyl group, and a tricyclo[5.2.1.0^{2,6}]decanyl group, and bicyclo[4.3.0]nonane.

The alicyclic hydrocarbon group may further have a substituent. Examples of the substituent include an alkyl group, an alkenyl group, an aryl group, an aralkyl group, an alkoxy group, a hydroxy group, a primary amino group, a secondary amino group, a tertiary amino group, an alkyl carbonyl group, an aryl carbonyl group, and a cyano group.

The alicyclic hydrocarbon group may further form a condensed ring.

The alicyclic hydrocarbon group in the invention preferably has an alicyclic hydrocarbon group portion having 5 to 20 carbon atoms from the viewpoint of viscosity and solubility.

Examples of a linking group for bonding the alicyclic hydrocarbon group to the structural portion derived from alcohol include an alkyl group, an alkenyl group, an alkylene group, an aralkyl group, an alkoxy group, a mono- or oligo-ethylene glycol group, and a mono- or oligo-propylene glycol group, each having 1 to 20 carbon atoms.

Specific example of the alicyclic (meth) acrylate in the invention are shown below, but the invention is not limited thereto. One kind of these compounds may be used singly, or two or more kinds may be used in combination.

Examples of the monocyclic(meth)acrylate include cycloalkyl(meth)acrylate having a cycloalkyl group having 3 to 10 carbon atoms, such as cyclopropyl(meth)acrylate, cyclobutyl(meth)acrylate, cyclopentyl(meth)acrylate, cyclohexyl(meth)acrylate, cycloheptyl(meth)acrylate, cyclooctyl(meth)acrylate, cyclononyl(meth)acrylate, and cyclodecyl(meth)acrylate.

Examples of the bicyclic(meth)acrylate include isobornyl(meth)acrylate and norbornyl(meth)acrylate.

Examples of the tricyclic(meth)acrylate include adamanthyl(meth)acrylate, dicyclopentanil(metha)acrylate, and dicyclopentenyloxyethyl(meth)acrylate.

Among the above, from the viewpoint of the dispersion stability of the self-dispersing polymer particles, fixability, and blocking resistance, at least either one of the bicyclic(meth)acrylate or the polycyclic(meth)acrylate of tri- or higher cycle is preferable and at least one selected from isobornyl(meth)acrylate, adamanthyl(meth)acrylate, or dicyclopentanil(meth)acrylate is more preferable.

In the invention, the content of the constituent unit derived from the alicyclic(meth)acrylate contained in the self-dispersing polymer particles is preferably from 20% by mass to 90% by mass and more preferably from 40% by mass to 90% by mass from the viewpoint of the stability of a self-dispersion state, stabilization of the particle shape in an aqueous medium due to hydrophobic interaction of alicyclic hydrocarbon groups, and reduction in the amount of water-soluble components due to appropriate hydrophobization of particles. The content thereof is particularly preferably from 50% by mass to 80% by mass.

When the content of the constituent unit derived from alicyclic(meth)acrylate is 20% by mass or more, fixability and blocking may be improved. In contrast, when the constituent unit derived from alicyclic(meth)acrylate is 90% by mass or lower, the stability of polymer particles may be improved.

When a constituent unit derived from an aromatic group-containing monomer is included, the aromatic group-containing monomer is not particularly limited so long as it is a compound containing an aromatic group and a polymerizable group. The aromatic group may be either a group derived from an aromatic hydrocarbon or a group derived from an aromatic heterocyclic ring. In the invention, the aromatic group is preferably an aromatic group derived from the aromatic hydrocarbon, from a viewpoint of particle shape stability in the aqueous medium.

The polymerizable group may be either a polycondensating polymerizable group or an addition polymerizing polymerizable group. The polymerizable group is preferably an addition polymerizing polymerizable group, and more preferably, a group containing an ethylenically unsaturated bond from a viewpoint of particle shape stability in the aqueous medium.

The aromatic group-containing monomer in the invention is preferably a monomer containing an aromatic group derived from an aromatic hydrocarbon and an ethylenically unsaturated bond. One kind of the aromatic group-containing monomer may be used singly or two or more kinds of the aromatic group-containing monomers may be used in combination.

Examples of the aromatic group-containing monomer include phenoxyethyl(meth)acrylate, benzyl(meth)acrylate, phenyl(meth)acrylate, and styrenic monomer. Among them, from a viewpoint of the balance between the hydrophilicity and the hydrophobicity of the polymer chain and the ink fixing property, an aromatic group-containing (meth)acrylate monomer is preferred, and at least one selected from the group consisting of phenoxyethyl(meth)acrylate, benzyl(meth)acrylate, and phenyl(meth)acrylate is more preferable and, phenoxyethyl(meth)acrylate and benzyl(meth)acrylate are still more preferred.

When a styrenic monomer is used as an aromatic group-containing monomer, the content of a constituent unit derived from a styrenic monomer is preferably 20% by mass or lower, more preferably 10% by mass or lower, and still more preferably 5% by mass or lower, from the viewpoint of stability of self-dispersing polymer particles in which the monomer is used. It is further preferable that the self-dispersing polymer do not contain the constituent unit derived from a styrenic monomer.

Here, the styrenic monomer refers to styrene, substituted styrene (a-methyl styrene, chlorostyrene, etc.), or a styrene macromer having a polystyrene structural unit.

The self-dispersing polymer particles used in the invention may optionally include, for example, as a hydrophobic constituent unit, additional constituent unit(s) as well as a constituent unit derived from an aromatic group-containing monomer, in addition to a constituent unit derived from an alicyclic monomer.

The monomer which may be used for forming the additional constituent unit (hereinafter, may also be referred to as an “additional copolymerizable monomer”) is not particularly limited so long as it is a monomer copolymerizable with the hydrophilic group-containing monomer, the aromatic group-containing monomer and the alicyclic monomer. An alkyl group-containing monomer is preferred from a viewpoint of the flexibility of the polymer skeleton or easiness in control for the glass transition temperature (Tg).

Examples of the alkyl group-containing monomer include alkyl(meth)acrylates such as methyl(meth)acrylate, ethyl(meth)acrylate, isopropyl(meth)acrylate, n-propyl(meth)acrylate, n-butyl(meth)acrylate, isobutyl(meth)acrylate, t-butyl(meth)acrylate, hexyl(meth)acrylate, and ethylhexyl(meth)acrylate; ethylenically unsaturated monomers having a hydroxyl group such as hydroxymethyl(meth)acrylate, 2-hydroxyethyl(meth)acrylate, 2-hydroxypropyl(meth)acrylate, 4-hydroxybutyl(meth)acrylate, hydorxypentyl(meth)acrylate, and hydroxyhexyl(meth)acrylate; dialkylamino alkyl(meth)acrylates such as dimethylaminoethyl(meth)acrylate; (meth)acrylamides, for example, N-hydroxyalkyl(meth)acrylamide such as N-hydroxymethyl(meth)acrylamide, N-hydroxyethyl(meth)acrylamide, and N-hydroxybutyl(meth)acrylamide; and N-alkoxyalkyl(meth)acrylamides such as N-methoxymethyl(meth)acrylamide, N-ethoxymethyl(meth)acrylamide, N-(n-, iso)butoxymethyl(meth)acrylamide, N-methoxyethyl(meth)acrylamide, N-ethoxyethyl(meth)acrylamide, and N-(n-, iso)butoxyethyl(meth)acrylamide.

In particular, from the viewpoint of the flexibility of a polymer skeleton or easiness in control of the glass transition temperature (Tg) and from the viewpoint of dispersion stability of a self-dispersing polymer, at least one of (meth)acrylates containing a chain alkyl group having 1 to 8 carbon atoms is preferable, (meth)acrylates containing a chain alkyl group having 1 to 4 carbon atoms are more preferable, and methyl(meth)acrylate or ethyl(meth)acrylate is particularly preferable. Here, the chain alkyl group refers to an alkyl group having a straight chain or a branched chain.

In the invention, one kind of the additional copolymerizable monomers may be used singly or two or more kinds of the additional copolymerizable monomers may be used in combination.

When the self-dispersing polymer particles contain the additional constituent units, the content thereof is preferably from 10% by mass to 80% by mass, more preferably from 15% by mass to 75% by mass, and particularly preferably from 20% by mass to 70% by mass. When two or more kinds of monomers are used in combination for forming the additional constituent unit(s), the total content thereof is preferably in the range described above.

The self-dispersing polymer used in the invention is also preferably a polymer obtained by polymerizing at least three monomers, namely a combination of at least one alicyclic(meth)acrylate, an additional copolymerizable monomer including an aromatic group-containing (meth)acrylate, and a hydrophilic group-containing monomer, from the viewpoint of dispersion stability, and more preferably a polymer obtained by polymerizing at least three monomers, namely a combination of at least one alicyclic(meth)acrylate, (meth)acrylate containing a straight chain or branched chain alkyl group having 1 to 8 carbon atoms, and a hydrophilic group-containing monomer.

In the invention, the self-dispersing polymer is preferably a self-dispersing polymer which does not substantially contain a constituent unit having a substituent having high hydrophobicity such as a constituent unit derived from (meth)acrylate having a straight chain or branched chain alkyl group having 9 or more carbon atoms, a constituent unit derived from an aromatic group-containing macromonomer or the like, and the self-dispersing polymer is more preferably a self-dispersing polymer which does not contain a constituent unit having a substituent having high hydrophobicity such as a constituent unit derived from (meth)acrylate having a straight chain or branched chain alkyl group having 9 or more carbon atoms, a constituent unit derived from an aromatic group-containing macromonomer or the like, from the viewpoint of dispersion stability.

The self-dispersing polymer used in the invention may be a random copolymer in which each constituent unit is irregularly introduced or a block copolymer in which each constituent unit is regularly introduced. In the case of a block copolymer, each constituent unit may be synthesized in any introduction order and the same constituent may be used twice or more. A random copolymer is preferable in terms of versatility and manufacturability.

The molecular weight of the self-dispersing polymer used in the invention is, preferably, from 3,000 to 200,000 and, more preferably, from 5,000 to 150,000 and, further preferably, from 10,000 to 100,000 in terms of the weight average molecular weight. Further, the self-dispersing polymer preferably has an acid value of from 25 to 100 and a weight average molecular weight of from 3,000 to 200,000, and the self-dispersing polymer more preferably has an acid value of from 25 to 95 and a weight average molecular weight of from 5,000 to 150,000. When the weight average molecular weight is 3,000 or more, the amount of the water-soluble component can be suppressed effectively. Further, when the weight average molecular weight is 200,000 or less, the self-dispersion stability can be increased.

The weight average molecular weight is measured by gel permeation chromatography (GPC). In GPC, HLC-8020GPC (manufactured by Tosoh Corporation) is used, and 3 pieces of columns of TSK GEL SUPER HZM-H, TSK GEL SUPER HZ4000 and TSK GEL SUPER HZ200 (trade names, manufactured by Tosoh Corporation, 4.6 mm ID×15 cm) are used, and THF (tetrahydrofuran) is used as an eluent.

It is preferable that the self-dispersing polymer used in the invention contain constituent unit(s) derived from alicyclic (meth)acrylate(s) (preferably structural units derived from at least one of isobornyl(meth)acrylate, adamanthyl(meth)acrylate, and dicyclopentanyl(meth)acrylate) in a proportion of from 15% by mass to 80% by mass of the total mass of the self-dispersing polymer particles as a copolymerization ratio, have an acid value of from 25 to 100, and a weight average molecular weight of from 3000 to 200,000 from the viewpoint of controlling hydrophilic and hydrophobic properties of the polymers.

It is also preferable that the self-dispersing polymer contain constituent unit(s) derived from alicyclic (meth)acrylate(s) (preferably structural unit(s) derived from at least one of isobornyl(meth)acrylate, adamanthyl(meth)acrylate, or dicyclopentanyl(meth)acrylate) in a proportion of from 15% by mass to 80% by mass of the total mass of the self-dispersing polymer particles as a copolymerization ratio, a constituent unit derived from carboxyl group-containing monomer(s), and a constituent unit derived from alkyl group-containing monomer(s) (preferably a structural unit derived from an alkyl ester of (meth)acrylic acid) from the viewpoint of controlling hydrophilic and hydrophobic properties of the polymers. It is more preferable that the self-dispersing polymers contain structural unit(s) derived from at least one of isobornyl (meth)acrylate, adamanthyl (meth)acrylate, and dicyclopentanyl(metha)acrylate in a proportion of from 15 to 80% by mass as a copolymerization ratio, a constituent unit derived from carboxyl group-containing monomer(s), and a constituent unit derived from alkyl group-containing monomer(s) (preferably a structural unit derived from an alkyl ester (having 1 to 4 carbon atoms) of (meth)acrylic acid), have an acid value of from 25 to 95, and have a weight average molecular weight of from 5,000 to 150,000.

It is also preferable that the self-dispersing polymer used in the invention be a vinyl polymer containing structure(s) derived from alicyclic (meth)acrylate(s) (preferably structural unit(s) derived from at least one of isobornyl(meth)acrylate, adamanthyl(meth)acrylate, or dicyclopentanyl(meth)acrylate) in a proportion of from 20% by mass to 90% by mass as a copolymerization ratio, a structure derived from dissociative group-containing monomer(s), at least one structure derived from (meth)acrylate(s) containing a chain alkyl group having 1 to 8 carbon atoms, have an acid value of from 20 to 120, have a total content of hydrophilic structural units of 25% by mass or lower, and have a weight average molecular weight of from 3,000 to 200,000, from the viewpoint of controlling hydrophilic and hydrophobic properties of the polymer. It is more preferable that the self-dispersing polymer used in the invention be a vinyl polymer containing a structure derived from polycyclic (meth)acrylate(s) having two rings or at least three rings (preferably a structural unit derived from at least one of isobornyl (meth)acrylate, adamanthyl (meth)acrylate, or dicyclopentanyl(metha)acrylate) in a proportion of from 30% by mass to 90% by mass as a copolymerization ratio, a structure derived from (meth)acrylate(s) containing a chain alkyl group having 1 to 4 carbon atoms in a proportion of from 10% by mass to 80% by mass as a copolymerization ratio, and a structure derived from carboxyl group-containing monomer(s) in such an amount that the acid value is in the range of from 25 to 100, have a total content of hydrophilic structural units of 25% by mass or lower, and have a weight average molecular weight of from 10000 to 200,000. It is particularly preferable that the self-dispersing polymer used in the invention be a vinyl polymer containing a structure derived from polycyclic (meth)acrylate(s) having two rings or at least three rings (preferably a structural unit derived from at least one of isobornyl (meth)acrylate, adamanthyl (meth)acrylate, or dicyclopentanyl(metha)acrylate) in a proportion of from 40% by mass to 80% by mass as a copolymerization ratio, a structure derived at least from methyl(meth)acrylate(s) or ethyl (meth)acrylate(s) in a proportion of from 20% by mass to 70% by mass as a copolymerization ratio, and a structure derived from acrylic acid(s) or methacrylic acid(s) in such an amount that the acid value is in the range of from 30 to 80, have a total content of hydrophilic structural units of 25% by mass or lower, and have a weight average molecular weight of from 30,000 to 150,000.

Examples of polymers used in the resin particles include following alicyclic group-containing polymers, but the invention is not limited to the following examples. The ratio in the brackets represents the mass ratio of copolymerization components. When the glass transition temperature is “calculated Tg”, the glass transition temperature is a value obtained by the calculation according to Equation (1) described above using a Tg value of a homopolymer of each of the following monomers. That is, Tg of a homopolymer of methyl methacrylate is 105° C., Tg of a homopolymer of isobornyl methacrylate is 156° C., Tg of a homopolymer of benzyl methacrylate is 54° C., Tg of a homopolymer of methacrylic acid is 130° C., Tg of a homopolymer of adamantyl methacrylate is 140° C., and Tg of a homopolymer of dicyclopentanyl methacrylate is 128° C.

Methyl methacrylate/isobornyl methacrylate/methacryic acid copolymer (20/72/8), Tg: 180° C.

Methyl methacrylate/isobornyl methacrylate/methacryic acid copolymer (30/62/8), Tg: 170° C.

Methyl methacrylate/isobornyl methacrylate/methacryic acid copolymer (40/52/8), Tg: 160° C.

Methyl methacrylate/isobornyl methacrylate/methacryic acid copolymer (50/42/8), Tg: 150° C.

Methyl methacrylate/isobornyl methacrylate/benzyl methacrylate/methacryic acid copolymer (30/50/14/6), Tg: 123° C.

Methyl methacrylate/dicyclopentanyl methacrylate/methacryic acid copolymer (40/50/10), Glass transition temperature Tg: 130° C.

Methyl methacrylate/dicyclopentanyl methacrylate/phenoxy ethyl methacrylate/methacryic acid copolymer (30/50/14/6), Tg: 101° C.

Methyl methacrylate/isobornyl methacrylate/methoxypolyethylene glycol methacrylate (n=2)/methacryic acid copolymer (30/54/10/6), Tg: 110° C.

Methyl methacrylate/dicyclopentanyl methacrylate/methoxypolyethylene glycol methacrylate (n=2)/methacryic acid copolymer (54/35/5/6), Tg: 100° C.

Methyl methacrylate/adamantyl methacrylate/methoxypolyethylene glycol methacrylate (n=23)/methacryic acid copolymer (30/50/15/5), Tg: 112° C.

Methyl methacrylate/isobornyl methacrylate/dicyclopentanyl methacrylate/methacryic acid copolymer (20/50/22/8), Tg: 139° C.

Ethyl methacrylate/cyclohexyl methacrylate/acrylic acid copolymer (50/45/5), Tg: 67° C.

Isobutyl methacrylate/cyclohexyl methacrylate/acrylic acid copolymer (40/50/10), Tg: 70° C.

n-Butyl methacrylate/cyclohexyl methacrylate/styrene/acrylic acid copolymer (30/55/10/5), Glass transition temperature Tg: 86° C.

Methyl methacrylate/dicyclopentenyloxyethyl methacrylate/methacrylic acid copolymer (40/52/8), Tg: 78° C.

Lauryl methacrylate/dicyclopentenyloxyethyl methacrylate/methacrylic acid copolymer (3/87/10), Tg: 53° C.

The method of producing a water-insoluble polymer that is used in the resin particle used in the invention is not particularly limited. Examples of the method of producing the water-insoluble polymer include a method of performing emulsion polymerization under the presence of a polymerizable surfactant thereby covalently-bonding the surfactant and the water-insoluble polymer, and a method of copolymerizing a monomer mixture containing the hydrophilic group-containing monomer and the aromatic group-containing monomer by a known polymerization method such as a solution polymerization method or a bulk polymerization method. Among the polymerization methods described above, the solution polymerization method is preferred and a solution polymerization method in which an organic solvent is used is more preferred from a viewpoint of aggregation speed and the stability of droplet ejection of the ink composition.

From a viewpoint of the aggregation speed, it is preferred that the self-dispersing polymer particles used in the invention contain a polymer synthesized in an organic solvent, and the polymer has a carboxyl group (the acid value is preferably from 20 to 100), in which the carboxyl groups of the polymer are partially or entirely neutralized and the polymer is prepared as a polymer dispersion in a continuous phase of water. That is, the self-dispersing polymer particle used in the invention is prepared by a method including a step of synthesizing the polymer in the organic solvent and a dispersion step of forming an aqueous dispersion in which at least a portion of the carboxyl groups of the polymer is neutralized.

The dispersion step preferably includes the following step (1) and step (2).

Step (1): a step of stirring a mixture containing a polymer (water-insoluble polymer), an organic solvent, a neutralizing agent, and an aqueous medium.

Step (2): a step of removing the organic solvent from the mixture.

The step (1) is preferably a treatment that includes at first dissolving the polymer (water-insoluble polymer) in the organic solvent and then gradually adding the neutralizing agent and the aqueous medium, and mixing and stirring the mixture to obtain a dispersion. By adding the neutralizing agent and the aqueous medium to the solution of the water-insoluble polymer dissolved in the organic solvent, self-dispersing polymer particles having a particle size that enables higher storage stability can be obtained without requiring strong sharing force.

The method for stirring the mixture is not particularly limited and a generally used mixing and stirring apparatus can be used, and optionally, a disperser such as a ultrasonic disperser or a high pressure homogenizer can be used.

Preferable examples of the organic solvent include alcohol solvents, ketone solvents and ether solvents.

Examples of the alcohol solvent include isopropyl alcohol, n-butanol, t-butanol, and ethanol. Examples of the ketone solvent include acetone, methyl ethyl ketone, diethyl ketone, and methyl isobutyl ketone. Examples of the ether solvent include dibutyl ether and dioxane. Among the solvents, the ketone type solvent such as methyl ethyl ketone and the alcohol type solvent such as isopropyl alcohol are preferred. Further, with an aim of moderating the change of polarity at the phase transfer from an oil system to an aqueous system, combined use of isopropyl alcohol and methyl ethyl ketone is also preferred. By the combined use of the solvents, self-dispersing polymer particles of small particle size with no aggregation settling or fusion between particles to each other and having high dispersion stability may be obtained.

The neutralizing agent is used to partially or entirely neutralize the dissociative groups so that the self-dispersing polymer can form a stable emulsified or dispersed state in water. When the self-dispersing polymer used in the invention has an anionic dissociative group (for example, carboxyl group) as the dissociative group, examples of the neutralizing agent to be used include basic compounds such as organic amine compounds, ammonia, and alkali metal hydroxides. Examples of the organic amine compounds include monomethyl amine, dimethyl amine, trimethyl amine, monoethyl amine, diethyl amine, triethyl amine, monopropyl amine, dipropyl amine, monoethanol amine, diethanol amine, triethanol amine, N,N-dimethyl-ethanol amine, N,N-diethyl-ethanol amine, 2-dimethylamino-2-methyl-1-propanol, 2-amino-2-methyl-1-propanol, N-methyldiethanol amine, N-ethyldiethanol amine, monoisopropanol amine, diisopropanol amine, and triisopropanol amine, etc. Examples of the alkali metal hydroxide include lithium hydroxide, sodium hydroxide and potassium hydroxide. Among them, sodium hydroxide, potassium hydroxide, triethylamine, and triethanol amine are preferred from a viewpoint of the stabilization of dispersion in water of the self-dispersing polymer particles used in the invention.

The basic compound is used preferably in an amount of from 5 to 120 mol %, more preferably, from 10 to 110 mol %, and further preferably, from 15 to 100 mol %, relative to 100 mol % of the dissociative groups. When the basic compound is used in an amount of 15mol % or more, the effect of stabilizing the dispersion of the particles in water may be more significantly obtained and when the basic compound is in an amount of 100 mol % or less, the effect of decreasing the water-soluble component may be more significantly achieved.

In the step (2), an aqueous dispersion of the self-dispersing polymer particles can be obtained by phase transfer to the aqueous system by distilling off the organic solvent from the dispersion obtained in the step (1) by a common method such as distillation under a reduced pressure. In the obtained aqueous dispersion, the organic solvent has been substantially removed and the amount of the organic solvent is preferably from 0.2% by mass or less and, more preferably, 0.1% by mass or less.

The average particle size of the resin particles is, as a volume average particle size, preferably in the range of 10 nm to 1 μm, more preferably in the range of from 10 nm to 200 nm, even more preferably in the range of from 10 nm to 100 nm, and particularly preferably in the range of from 10 nm to 50 nm. When the volume average particle size is 10 nm or more, production suitability may be improved, and when the volume average particle size is 1 μm or less, storage stability may be enhanced.

The particle size distribution of the resin particles is not particularly limited, and any of those particles having a broad particle size distribution or those particles having a monodisperse particle size distribution may be used. Two or more kinds of water-insoluble particles may be used as a mixture.

The average particle size and particle size distribution of the resin particles are determined by measuring the volume average particle size by a dynamic light scattering method, using a NANOTRACK particle size distribution analyzer (model name: UPA-EX150, manufactured by Nikkiso Co., Ltd.).

One kind of the resin particles (particularly, for example, self-dispersing polymer particles) can be used singly or two or more kinds thereof may be used in combination. The content of the resin particles in the ink composition is preferably 0.5 to 20% by mass, more preferably from 2% by mass to 20% by mass, and still more preferably from 3% by mass to 15% by mass, relative to the total mass of the ink composition.

The content of the resin particles relative to the total mass of the solid content in the ink composition is preferably 40% by mass or more. When the proportion relative to the total mass of the solid content is in the range mentioned above, in a case where high speed recording is performed using, for example, a single pass method, sufficient aggregation properties for obtaining high resolution images may be obtained and the occurrence of blocking and offset can be effectively suppressed. Moreover, for similar reasons as described above, the content of the resin particles in the ink composition is more preferably from 40% by mass to 90% by mass, still more preferably from 40% by mass to 80% by mass, and most preferably from 50% by mass to 70% by mass, relative to the total mass of the solid content in the ink composition.

Water-Soluble Organic Solvent

The ink composition used in the invention contains at least one water-soluble organic solvent.

The water-soluble organic solvent may be used for drying prevention, wetting or penetration promotion. For drying prevention, the water-soluble organic solvent is used as a drying preventing agent for preventing clogging of an ink ejection opening of an ejection nozzle due to an aggregate formed of adhered and dried inks. For preventing drying and/or for wetting, water-soluble organic solvents having a low vapor pressure than that of water are preferable. For promoting penetration, the water-soluble organic solvents can be used as a penetration accelerator that increases penetration properties of inks in paper.

Examples of the water-soluble organic solvents include alkanediols (polyhydric alcohols), such as glycerol, 1,2,6-hexanetriol, trimethylolpropane, ethylene glycol, propylene glycol, diethylene glycol, triethylene glycol, tetraethylene glycol, pentaethylene glycol, dipropylene glycol, 2-butene-1,4-diol, 2-ethyl-1,3-hexanediol, 2-methyl-2,4-pentanediol, 1,2-octanediol, 1,2-hexanediol, 1,2-pentanediol, or 4-methyl-1,2-pentanediol; saccharides, such as glucose, mannose, or fructose; sugar alcohols; hyaluronic acids; alkyl alcohols having 1 to 4 carbon atoms, such as ethanol, methanol, butanol, propanol, or isopropanol; glycol ethers, such as ethylene glycol monomethyl ether, ethylene glycol monoethyl ether, ethylene glycol monobutyl ether, ethylene glycol monomethyl ether acetate, diethylene glycol monomethyl ether, diethylene glycol monoethyl ether, diethylene glycol mono-n-propyl ether, ethylene glycol mono-iso-propyl ether, diethylene glycol mono-iso-propyl ether, ethylene glycol mono-n-butyl ether, ethylene glycol mono-t-butyl ether, diethylene glycol mono-t-butyl ether, 1-methyl-1-methoxybutanol, propylene glycol monomethyl ether, propylene glycol monoethyl ether, propylene glycol mono-t-butyl ether, propylene glycol mono-n-propyl ether, propylene glycol mono-iso-propyl ether, dipropylene glycol monomethyl ether, dipropylene glycol monoethyl ether, tripropylene glycol monomethyl ether, dipropylene glycol mono-n-propyl ether, or dipropylene glycol mono-iso-propyl ether; 2-pyrrolidone, and N-methyl-2-pyrrolidone. Only one kind of these alcohols may be used singly, or two or more kinds thereof may be used in combination.

For drying prevention or wetting, polyhydric alcohols are useful. Examples of the polyhydric alcohol include glycerol, ethylene glycol, diethylene glycol, triethylene glycol, propylene glycol, dipropylene glycol, tripropylene glycol, 1,3-butanediol, and 2,3-butanediol. Only one kind of these polyhydric alcohols may be used singly or two or more kinds thereof may be used in combination.

For promoting penetration, polyol compounds are preferable and aliphatic diols are suitable. Examples of the aliphatic diols include 2-ethyl-2-methyl-1,3-propanediol, 3,3-dimethyl-1,2-butanediol, 2,2-diethyl-1,3-propanediol, 2-ethyl-1,3-hexanediol, and 2,2,4-trimethyl-1,3-pentanediol. Among the above, preferable examples include 2-ethyl-1,3-hexanediol and 2,2,4-trimethyl 1,3-pentanediol.

With respect to the ink composition used in the invention, 70% by mass or more of the water-soluble organic solvents are water-soluble organic solvents having an SP value of 27.5 or lower. When the water-soluble organic solvents having an SP value of 27.5 or lower are used, the occurrence of curling under various environmental humidity after recording can be further suppressed. Moreover, the fixability may also increase due to interaction with resin particles. In particular, when the proportion of water-soluble organic solvents having a relatively low SP value are increased by adjusting the proportion of the water-soluble organic solvents having an SP value of 27.5 or lower to be 70% by mass or more of the whole water-soluble organic solvents, the scratch resistance of images can be increased and offset can be effectively suppressed.

The SP value (solubility parameter) of a water-soluble solvent as used in the invention is a value expressed by the square root of cohesive energy of molecules. SP values can be calculated by the method described in R. F. Fedors, Polymer Engineering Science, 14, pp. 147 to 154 (1974).

In order to prevent clogging at a nozzle opening of a head due to drying of ink jet ink compositions at the nozzle head, the solvents can be used for preventing drying or wetting. For drying prevention or wetting, water-soluble organic solvents having a lower vapor pressure than that of water are preferable. In order to more sufficiently penetrate the ink composition in paper, the water-soluble organic solvents are preferably used for promoting the penetration.

Preferable examples of the water-soluble organic solvents having an SP value of 27.5 or lower include the following compounds.

Diethylene glycol monoethyl ether (SP value: 22.4)

Diethylene glycol monobutyl ether (SP value: 21.5)

Triethylene glycol monomethyl ether (SP value: 22.1)

Triethylene glycol monoethyl ether (SP value: 21.7)

Triethylene glycol monobutyl ether (SP value: 21.1)

Dipropylene glycol monomethyl ether (SP value: 21.3)

Dipropylene glycol (SP value: 27.2)

Tripropylene glycol monomethyl ether (20.4)

Alkylene oxide adduct of glycerol represented by the following Formula (1)

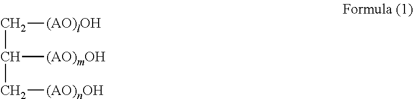

In Formula (1), l, m, and n each independently represent an integer of 1 or more, and the sum of l, m and n (l+m+n) is from 3 to 15. When the value of l+m+n is 3 or more, the effect of suppressing curling may be favorable. When the value of l+m+n is 15 or lower, favorable ejection properties may be maintained. In particular, the value of l+m+n is preferably in the range of from 3 to 12 and more preferably in the range of from 3 to 10. AO in Formula (1) represents ethyleneoxy (which may sometimes be abbreviated as EO) and/or propyleneoxy (which may sometimes be abbreviated as PO). In particular, a propyleneoxy group is preferable. Each AO of (AO)₁, (AO)ₘ, and (AO)ₙ may be the same or different.

Examples of the compound represented by Formula (1) are shown below. However, the present invention is not limited to these compounds. The value in the brackets is an SP value.

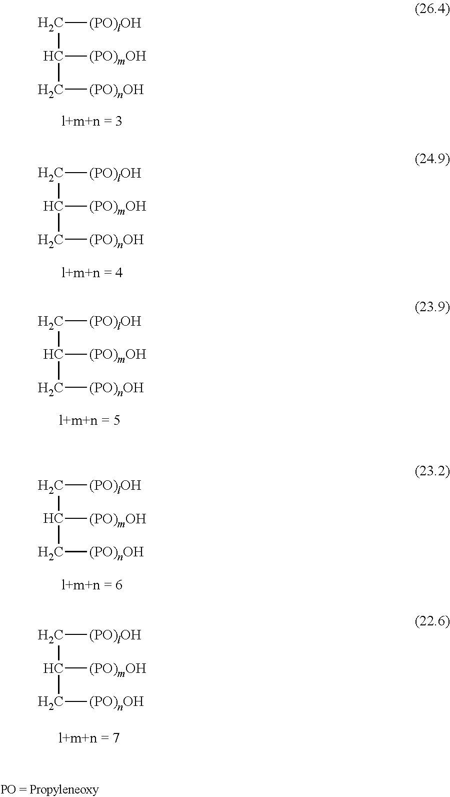

nC₄H₉O(AO)₄—H
(AO═EO or PO (EO:PO=1:1), SP value=20.1)

nC₄H₉O(AO)₁₀—H
(AO═EO or PO (EO:PO=1:1), SP value=18.8)

HO(A′O)₄₀—H
(A′O=EO or PO (EO:PO=1:3), SP value=18.7)

HO(A″O)₅₅—H
(A″O=EO or PO (EO:PO=5:6), SP value=18.8)

HO(PO)₃—H (SP value=24.7)

HO(PO)₇—H (SP value=21.2)

1,2-hexanediol (SP value=27.4)

EO represents an ethylene oxy group and PO represents a propyleneoxy group.

As the alkylene oxide adduct of glycerol, any of commercially available products currently marketed may be used. Examples of the commercially available alkylene oxide adduct of glycerol include, as polyoxypropylated glycerol (ether of polypropylene glycol and glycerol), SANNIX GP-250 (average molecular weight: 250), SANNIX GP-400 (average molecular weight: 400), and SANNIX GP-600 (average molecular weight: 600) (trade names, manufactured by Sanyo Chemical Industries, Ltd.); LEOCON GP-250 (average molecular weight: 250), LEOCON GP-300 (average molecular weight: 300), LEOCON GP-400 (average molecular weight: 400), LEOCON GP-700 (average molecular weight: 700) (trade names, manufactured by LION Corporation); and polypropylenetriol glycol•triol types (average molecular weight: 300; and average molecular weight: 700) (manufactured by Wako Pure Chemical Industries, Ltd.).

One kind of the water-soluble organic solvent can be used singly or two or more kinds may be used a mixture. The combination for the mixture is not particularly limited. When an alkylene oxide adduct of glycerol represented by Formula (1) and an alkylene glycol alkyl ether having an SP value of 23 or lower (preferably SP value of 22 or lower) (preferably di- or tri-alkylene glycol monoalkyl ether (the number of carbon atoms of the alkyl portion is preferably 1 to 4) are combined, the fixability further may be increased and blocking of images can be effectively suppressed. In this case, the mixing ratio (a:b) of the alkylene oxide adduct of glycerol (a) represented by Formula (1) and the alkylene glycol alkyl ether having an SP value of 23 or lower (b) is preferably in the range of 1:5 to 5:1 and more preferably in the range of 1:2.5 to 2.5:1 for similar reasons as described above.

The ink composition preferably contains the water-soluble organic solvents in a proportion of lower than 20% by mass relative to the total mass of the composition. When high speed recording is performed using, for example, a single pass method, the content of the water-soluble organic solvents of lower than 20% by mass may be advantageous for performing treatment, such as drying, fixing, or the like after recording, in a short time and the occurrence of blocking and offset can be effectively suppressed.

In particular, the content of the water-soluble organic solvents is preferably 5% by mass or more and lower than 20% by mass and more preferably from 7% by mass to 17% by mass relative to the total mass of the composition.

Water

The ink composition used in the invention contains water, but the amount of water is not particularly limited. In particular, in terms of securing stability and ejection reliability, the amount of water is preferably from 10% by mass to 99% by mass, more preferably from 30% by mass to 80% by mass, and still more preferably from 50% by mass to 70% by mass, relative to the total mass of the ink composition.

Surfactant

The ink composition according to the invention may contain a surfactant, if necessary. The surfactant may be used as a surface tension adjusting agent.

As the surface tension adjusting agent, a compound having a structure in which a hydrophilic moiety and a hydrophobic moiety are contained in the molecule may be effectively used, and any of anionic surfactants, cationic surfactants, amphoteric surfactants, nonionic surfactants, and betaine surfactants may be used. Further, the dispersants (polymeric dispersant) as described above may be used as surfactants. The surface may be used singly or as a mixture of two or more kinds thereof

In the ink composition used in the invention, a dynamic surface tension may be adjusted properly. From the viewpoint of stable ejection in ink-jetting, acetylene glycol type surfactants may be preferably used as a surface tension adjusting agent. Specific examples of the surface tension adjusting agent include 2,4,7,9-tetramethyl-5-decyne-4,7-diol, 3,6-dimethyl-4-octyne-3,6-diol, and 3,5-dimethyl-1-hexyne-3-ol. Examples of the commercially available acetylene glycol type surfactants include SURFYNOL 104, 82, 465, 485, and TG (trade names, manufactured by Air Products & Chemicals, Inc. USA), OLFINE E-1010 (trade name, manufactured by Nissin Chemical Co., Ltd.), ACETYNOL EL and ACETYNOL EH (trade names, manufactured by Kawaken Fine Chemicals Co., Ltd.).

The specific amount of the surfactant in the ink composition is not particularly limited. However, the amount by which a surface tension described below can be obtained is preferable The amount of the surfactant(s) is preferably 1% by mass or more, more preferably from 1% by mass to 10% by mass, and even more preferably from 1% by mass to 3% by mass.

Other Components

The ink composition used in the invention may further contain various additives as other components according to necessity, in addition to the components described above.

Examples of the various additives include known additives such as an ultraviolet absorbent, a fading preventing agent, an anti-mold agent, a pH adjusting agent, an anti-rust agent, an antioxidant, an emulsion stabilizer, a preservative, an antifoaming agent, a viscosity adjusting agent, a dispersion stabilizer, and a chelating agent.

Solid Ingredients in a Solid State in a 25° C. Ink Composition

In the ink composition used in the invention, the total content of solid ingredients that are in a solid state in a 25° C. ink composition is preferably 2.0 mass % or more and lower than 20 mass % with respect to the ink composition. The total content is more preferably from 5 mass % to 18 mass % and still more preferably from 10 mass % to 15 mass %.

When the total content of the solid ingredients in the ink composition is lower than 20 mass %, the amount of liquid ingredients effective for preventing clogging of a nozzle can be reduced. As a result, occurrence of beading can be suppresses and a drying rate can be further increased. When the amount of the liquid ingredients is decreased, the amount of the liquid ingredients remaining near the recording medium surface of an image portion after recording decreases. Thus, drying is accelerated and fixability can be increased without preventing binding of solid ingredients (pigment and resin as a fixing agent) and binding of solid ingredients and a recording medium.

In contrast, when the total content of the solid ingredients in the ink composition is 2.0 mass % or more, the amount of the liquid ingredients (including water) in ink decreases and the amount of the liquid ingredients to be absorbed into a recording medium decreases, and thus drying is accelerated and occurrence of cockling in the recording medium is suppressed.

Examples of the solid ingredients that are in a solid state in a 25° C. ink composition include pigments, pigment dispersants, and resin particles. The details thereof are as described above.

The solid state in a 25° C. ink composition means that the ingredients are in a solid state in ink of room temperature and normal pressure (25° C., 1 atmosphere) as an environment in which usual ink-jet recording is performed.

Liquid Ingredients that has a Boiling Point Higher than that of Water and that are in a Liquid State in a 25° C. Ink Composition

The ink composition in the invention contains liquid ingredients that have a vapor pressure lower than that of water and that are in a liquid state in the ink composition of 25° C. and the ratio (A/B) of the total content (A) of the liquid ingredients in the ink composition and the total content (B) of the solid ingredients in the ink composition is preferably 0.70 to 1.75.

The liquid ingredients that have a boiling point than that of water and that are in a liquid state in a 25° C. ink composition are made mostly of water-soluble organic solvents having a high boiling point, and controlling agents for ink properties of surfactants or the like, are also the liquid ingredients, insofar as they have a boiling point higher than that of water and that are in a liquid state in a 25° C. ink composition.

In the ink composition used in the invention, the ratio (A/B) of the total content (A) of the liquid ingredients in the ink composition and the total content (B) of the solid ingredients in the ink composition is preferably 0.70 to 1.75. The ratio (A/B) is more preferably 1.00 to 1.70 and still more preferably 1.20 to 1.65.

Due to the ratio (A/B) of from 0.70 to 1.75, an ink jet recording device and an image forming method are provided in which occurrence of beading is suppressed, a drying rate has no problems, clear images close to an offset-printed image are obtained, and clogging of a nozzle does not occur during a long term suspension even when printing is performed on a coated paper for printing having a low liquid absorption ability. In particular, when the ratio (A/B) is 0.70 or more, clogging of a nozzle is hard to occur even during a long term suspension, and when the ratio (A/B) is 1.75 or lower, drying of record images is accelerated.

Properties of Ink Composition

The ink composition used in the invention has a surface tension at 25° C. of 30 mN/m to 40 mN/m. When the surface tension is lower than 30 mN/m, a nozzle plate of a recording device is excessively wet, resulting in a failure of the formation (granulating) of ink droplets, and thus stable ink ejection cannot be achieved and bleeding on a recording medium becomes noticeable. In contrast, when the surface tension exceeds 40 mN/m, ink does not sufficiently penetrate into a recording medium, thereby causing the occurrence of beading and prolonging drying time.

The surface tension is preferably in the range of 32 mN/m to 40 mN/m and more preferably from 32 mN/m to 38 mN/m, from the viewpoint of achieving stable ejection of ink droplets and resolution of printed images in combination.

Here, the surface tension is determined by measuring an ink composition under the conditions of 25° C. using an AUTOMATIC SURFACE TENSIOMETER CBVP-Z (trade name, manufactured by Kyowa Interface Science Co., LTD.). The surface tension of the ink composition can be adjusted by the added amount of surfactants as the surface tension controlling agent described above.

The viscosity at 25° C. of the ink composition is preferably from 1.2 mPa·s to 15.0 mPa·s, more preferably 2 mPa·s or more and lower than 13 mPa·s, and still more preferably 2.5 mPa·s or more and lower than 10 mPa·s. The viscosity is determined by measuring an ink using a VISCOMETER TV-22 (trade name, manufactured by TOKI SANGYO CO. LTD) under the conditions of 25° C.

Heating Process

In a heating process, images recorded in the image recording process are heated and fixed.

The heating process in the invention may be a drying process in which images are dried in the state where a heat source and the above-described recording medium are not in contact with each other, or may be a fixing process in which images are fixed in the state where a heat source and the recording medium are in contact with each other, or alternatively may be performed by both the processes.

Drying Process

In a drying process, at least one part of a solvent in the ink applied to the recording medium is removed by drying.

In the drying process in the invention, treatment is performed in the state where a heat source and the recording medium are not in contact with each other. The treatment method is not particularly limited, and specifically, the treatment can be carried out by applying generally used methods, such as air blowing (supply of dry air) from a heat source to an image portion.

When both the drying process and the fixing process are provided in the invention, it is preferable to provide the drying process before the fixing process from the viewpoint of effectively preventing an offset phenomenon.

Fixing Process

In a fixing process, an image portion is fixed (fixing treatment) by pressing a pressure bonding member containing a pressure-apply member for applying a pressure to the image portion and a heating member for heating the image portion in combination onto the image portion to pressurize and heat the image portion. Examples of the pressure-apply member include a pair of rolls in which the rolls are pressed against each other and a pressurizing plate. Examples of the heating member include a heating roll and a heating plate. Specifically, treatment of pressing the surface of a recording medium under pressure with a heating roll, a heating plate, or the like can be performed.

The fixing temperature in the fixing process is preferably lower than 100° C. The fixing temperature is more preferably 50° C. or higher and lower than 90° C. and still more preferably 60° C. or higher and lower than 80° C. When the fixing temperature is excessively low, fixation becomes insufficient and scratch resistance decreases in some cases. When the fixing temperature is excessively high, latex is softened and fixing offset increases in some cases.

In the invention, the fixing temperature refers to a temperature in a portion of the pressure bonding member contacting a recording medium.

The pressure for pressurizing is preferably in the range of 0.1 to 3.0 MPa, more preferably in the range of 0.1 to 1.0 MPa, and still more preferably in the range of 0.1 to 0.5 MPa in terms of smoothing the surface.

The image forming method of the invention includes at least the image recording process and the heating process and, as required, may further include other processes, such as a treating liquid supply process.

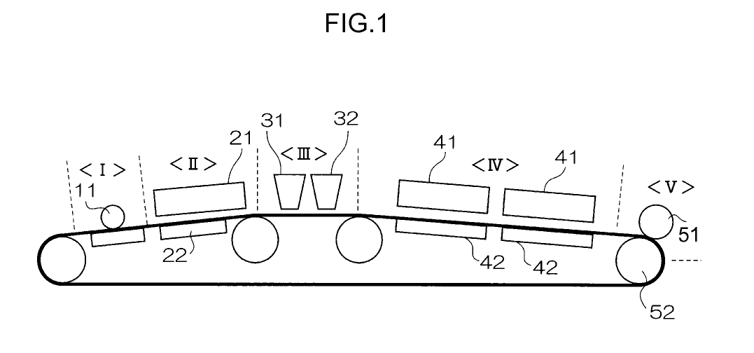

Treatment Liquid Supplying Step (Process <1> in FIG. 1)

The ink-jet recording method of the present invention preferably further includes supplying a treatment liquid with which an aggregate can be formed when the treatment liquid contacts the ink composition (treatment liquid supplying step), from the viewpoints of blocking resistance, scratch resistance and offset resistance of the images.

In the treatment liquid supplying step, the treatment liquid containing an aggregating agent for aggregating the components in the ink composition is supplied. When the ink jet recording using the ink composition is performed in the presence of the treatment liquid, the occurrence of curling and cockling of the medium after recording may be suppressed, ink cissing may also be suppressed, and images having favorable blocking resistance, offset resistance and scratch resistance may be recorded.

Treatment Liquid

The treatment liquid includes at least one aggregating agent. When the aggregating agent comes into contact with the ink composition, an aggregate can be formed. The aggregating agent may be appropriately selected from known compounds which are capable of causing aggregating, without particular limitation.

Examples of the aggregating agent include compounds capable of changing the pH of the ink composition, polyvalent metal salts, and cationic compounds. In the invention, compounds capable of changing the pH of the ink composition are preferable from the viewpoint of aggregation properties of the ink composition, and compounds capable of reducing the pH of the ink composition are more preferable.

Examples of the compounds capable of reducing the pH of the ink composition include acidic substances.

Examples of the acidic substances include sulfuric acid, hydrochloric acid, nitric acid, phosphoric acid, polyacrylic acid, acetic acid, glycolic acid, malonic acid, malic acid, maleic acid, ascorbic acid, succinic acid, glutaric acid, fumaric acid, citric acid, tartaric acid, lactic acid, sulfonic acid, orthophosphoric acid, metaphosphoric acid, pyrrolidone carboxylic acid, pyrone carboxylic acid, pyrrole carboxylic acid, furancarboxylic acid, pyridinecarboxylic acid, coumarinic acid, thiophene carboxylic acid, nicotinic acid, derivatives of the compounds, and salts thereof.

In particular, acidic substances having high water-solubility are preferable. From the viewpoint of fixing the whole ink upon reacting with the ink composition, acidic substances having three or lower valences are preferable and acidic substances having two to three valences are more preferable.

One kind of the acidic substances may be used singly or two or more kinds of the acidic substances may be used in combination.

When the treatment liquid in the invention contains the acidic substances, the pH (25° C.) of the treatment liquid is preferably from 0.1 to 6.0, more preferably from 0.5 to 5.0, and still more preferably from 0.8 to 4.0.

Examples of the polyvalent metal salt include salts of any of alkaline earth metals belonging to Group II of the periodic table (e.g., magnesium and calcium), transition metals belonging to Group III of the periodic table (e.g., lanthanum), cations from Group XIII of the periodic table (e.g., aluminum), and lanthanides (e.g., neodymium). As salts of the metals, carboxylic acid salt (formate, acetate, benzoate, etc.), nitrate, chlorides, and thiocyanate are preferable. In particular, calcium salts or magnesium salts of carboxylic acids (e.g., formate, acetate, and benzoate), calcium salts or magnesium salts of nitric acid, calcium chloride, magnesium chloride, and calcium salts or magnesium salts of thiocyanic acid are preferable.

The cationic compound may be, for example, preferably a cationic surfactant. Preferred examples of the cationic surfactant include compounds of primary, secondary or tertiary amine salt type. Examples of these amine salt type compounds include compounds such as hydrochlorides or acetates (for example, laurylamine, palmitylamine, stearylamine, rosin amine), quaternary ammonium salt type compounds (for example, lauryltrimethylammonium chloride, cetyltrimethylammonium chloride, lauryldimethylbenzylammonium chloride, benzyltributylammonium chloride, benzalkonium chloride (alkyldimethylbenzylammonium chloride)), pyridinium salt type compounds (for example, cetylpyridinium chloride, cetylpyridinium bromide), imidazoline type cationic compounds (for example, 2-heptadecenylhydroxyethylimidazoline), and ethylene oxide adducts of higher alkylamines (for example, dihydroxyethylstearylamine). A polyallylamine compound may be used. Further, amphoteric surfactants exhibiting cationic properties in a desired pH region may also be used, examples of which include amino acid type amphoteric surfactants, R—NH—CH₂CH₂—COOH type compounds wherein R represents an alkyl group or the like, carboxylic acid salt type amphoteric surfactants (for example, stearyldimethylbetaine, lauryldihydroxyethylbetaine), amphoteric surfactants of sulfuric acid ester type, sulfonic acid type or phosphoric acid ester type.

One kind of aggregating agent may be used singly or two or more kinds of aggregating agents may be used in combination.

The content of the aggregating agent(s) for aggregating components of the ink composition in the treatment liquid is preferably from 1 to 50% by mass, more preferably from 3 to 45% by mass, and even more preferably from 5 to 40% by mass.

When at least one of an acidic substance or a cationic compound is used in combination with the polyvalent metal compound, the content of the acidic substance and the cationic compound in the treatment liquid (total content of the acidic substance and the cationic compound) is preferably from 5% by mass to 95% by mass, and more preferably from 20% by mass to 80% by mass, relative to the total content of the polyvalent metal compound.

The treatment liquid according to the present invention may contain, in general, a water-soluble organic solvent in addition to the aggregating agent, and may also contain various other additives. Details of the water-soluble organic solvent and the various other additives are similar to those for the ink composition.

The surface tension (25° C.) of the treatment liquid is preferably from 20 mN/m to 60 mN/m. More preferably, the surface tension is from 25 mN/m to 50 mN/m, and is even more preferably from 25 mN/m to 45 mN/m.

The surface tension of the treatment liquid is measured under the conditions of a temperature of 25° C. using an automatic surface tensiometer (model name: CBVP-Z, manufactured by Kyowa Interface Science Co., Ltd.).

In regard to the supplying of the treatment liquid on coated paper, known liquid supplying methods may be used without any particular limitation. Any method such as spray coating, coating with a coating roller, supplying by an ink jet method, and dipping may be selected.

Specific examples of a liquid supplying method include size press methods represented by a horizontal size press method, a roll coater method, a calender size press method or the like; knife coater methods represented by an air knife coater method; roll coater methods represented by a transfer roll coater method such as a gate roll coater method, a direct roll coater method, a reverse roll coater method, a squeeze roll coater method or the like; blade coater methods represented by a billblade coater method, a short dwell coater method, a two stream coater method; bar coater methods represented by a rod bar coater method; cast coater methods; gravure coater method; curtain coater methods; die coater methods; brush coater methods; and transfer methods.

Furthermore, a method of coating in which the coating amount is controlled using a coating apparatus equipped with a liquid amount controlling member, as in the case of the coating apparatus described in JP-A No. 10-230201, may be used.

The treatment liquid may be supplied over the entire surface of the recording medium (coated paper). Alternatively, the treatment liquid may be partially supplied to a region where ink-jet recording is performed in the subsequent image recording step. According to the invention, in view of uniformly adjusting the amount of supplying of the treatment liquid, uniformly recording fine lines, fine image portions or the like, and suppressing image unevenness such as density unevenness, it is preferable that the treatment liquid is supplied over the entire surface of the coated paper by coating the liquid using a coating roller or the like.

Examples of the method of coating the treatment liquid while controlling the amount of supply of the aggregating agent to the above-described range include a method of using an anilox roller 11 (FIG. 1). The anilox roller is a roller in which the roller surface, being thermal spray coated with ceramics, is processed with laser and provided with a pattern of a pyramidal shape, a slant-lined shape, a hexagonal shape or the like on the surface. The treatment liquid goes into the depression areas provided on this roller surface, and when the roller surface contacts the paper surface, transfer occurs, and the treatment liquid is coated in an amount that is controlled by the depressions of the anilox roller.

Dry Removal Process (Process <2> in FIG. 1)

In the invention, it is preferable to provide a dry removal process for removing a solvent contained in an aqueous treatment liquid by drying after the aqueous treatment liquid is supplied by the treatment liquid supply process. By removing the solvent in the aqueous treatment liquid by drying after the aqueous treatment liquid is supplied, the occurrence of curling, cockling, or cissing is more effectively suppressed, the abrasion resistance of the recorded images can be further increased, and the recording of images is more favorably performed.

The dry removal step is not particularly limited insofar as at least a part of the solvent (e.g., water or a water-soluble organic solvent) contained in the aqueous treatment liquid can be removed. The removal by drying can be carried out by, for example, a drying method by heating, or air blowing (for example, blowing dry air with a drying fan 21 while being heated with a contact type plate heater 22, or the like).

### Examples

Hereinafter, the invention will be more specifically described with reference to Examples, but the invention is not limited to the following Examples insofar as the gist thereof is not exceeded. Unless otherwise specified, “part” and “%” are all based on mass.

### Production Example 1

### Preparation of Polymer Solution A

A 1 L flask equipped with a mechanical stirrer, a thermometer, a nitrogen gas introducing tube, a reflux tube, and a drop funnel was sufficiently charged with nitrogen gas. Then, 11.2 g of styrene, 2.8 g of acrylic acid, 12.0 g of lauryl methacrylate, 4.0 g of polyethylene glycol methacrylate, 4.0 g of styrene macromer (trade name: AS-6, manufactred by TOAGOSEI Co., LTD.), and 0.4 g of mercaptoethanol were mixed and the temperature was increased to 65° C. Subsequently, a mixed solution of 100.8 g of styrene, 25.2 g of acrylic acid, 108.0 g of lauryl methacrylate, 36.0 g of polyethylene glycol methacrylate, 60.0 g of hydroxyethyl methacrylate, 36.0 g of styrene macromer (trade name: AS-6, manufactred by TOAGOSEI Co., LTD.), 3.6 g of mercaptoethanol, 2.4 g of azobismethyl valeronitrile, and 18 g of methyl ethyl ketone was added dropwise into the flask over 2.5 hours. After the dropwise addition, a mixed solution of 0.8 g of azobismethyl valeronitrile and 18 g of methyl ethyl ketone was added dropwise into the flask over 0.5 hours. After maturing at 65° C. for 1 hour, 0.8 g of azobismethyl valeronitrile was added, and then the mixture was further matured for 1 hour. After the completion of the reaction, 364 g of methyl ethyl ketone was added into the flask, thereby preparing 800 g of polymer solution A having a concentration of 50% by mass.

### Production Example 1-1

Preparation of Cyan Pigment Dispersion C-1

Next, 46 g of the obtained polymer solution A, 33 g of pigment blue 15:3 (trade name: PHTHALOCYANINE BLUE A220, manufactured by Dainichiseika Color & Chemicals Mfg. Co., Ltd), 13.6 g of 1 mol/L aqueous potassium hydroxide solution, 20 g of methyl ethyl ketone, and 13.6 g of ion exchanged water were sufficiently stirred, and then kneaded using a roll mill. The obtained paste was poured into 200 g of pure water, and sufficiently stirred. Then, methyl ethyl ketone and water were distilled off using an evaporator, and then glycerol was added, thereby preparing a cyan pigment dispersion C-1 containing 10.9% by mass of pigment, 7.5% by mass (solid content of 18.4% by mass) of resin, and 9.1% by mass of glycerol.

### Production Example 1-2

### Preparation of Magenta Pigment Dispersion M-1

A water dispersion of magenta pigment polymer particles was prepared in the same manner as in Production Example 1-1, except for using CHROMOPHTHAL JET MAGENTA DMQ (trade name, pigment red 122, manufactured by Ciba Specialty Chemicals) in place of the pigment blue 15:3 in Production Example 1-1. The magenta pigment dispersion M-1 contained 13.6% by mass of pigment, 4.5% by mass (solid content of 18.1% by mass) of resin, and 9.1% by mass of glycerol.

### Production Example 1-3

### Preparation of Yellow Pigment Dispersion Y-1

A water dispersion of yellow pigment polymer particles was produced in the same manner as in Production Example 1-1, except for using IRGALITE YELLOW GS (trade name, pigment yellow 74, manufactured by Ciba Specialty Chemicals) in place of the pigment blue 15:3 in Production-Example 1-1. The yellow pigment dispersion Y-1 contained 10.9% by mass of pigment, 7.5% by mass (solid content of 18.4% by mass) of resin, and 9.1% by mass of glycerol.

### Production Example 2

### Production of Black Pigment Dispersion K-1

Into 3,000 ml of 2.5 N sodium sulphate solution, 90 g of carbon black having a CTAB specific surface area of 150 m²/g and a DBP oil absorption amount of 100 ml/100 g was added. The mixture was stirred at a speed of 300 rpm and at 60° C., and reacted for 10 hours to be subjected to oxidation treatment. The reaction solution was filtrated to take carbon black. The obtained carbon black was neutralized with sodium hydroxide solution and subjected to ultra filtration. The obtained carbon black was washed with water and dried, and then dispersed in pure water so that the pigment was adjusted to 20% by mass (solid content of 20% by mass), thereby preparing a black pigment dispersion K-1.

### Production Example 3

### Preparation of Aqueous Dispersion of Resin Particles A

A 1 L flask equipped with a mechanical stirrer, a thermometer, a nitrogen gas introducing tube, a reflux tube, and a drop funnel was sufficiently charged with nitrogen gas. Then, 8.0 g of LATEMUL S-180 (trade name, reactant emulsifier having unsaturated carbon, manufactured by Kao Corp., 100% by mass of ingredients) and 350 g of ion exchanged water were added and mixed, and then the temperature was increased to 65° C. After increasing the temperature, 3.0 g of t-butyl peroxy benzoate as a reaction initiator and 1.0 g of sodium isoascorbate were added. In 5 minutes, 45 g of methyl methacrylate, 160 g of 2-ethylhexyl methacrylate, 5 g of acrylic acid, 45 g of butyl methacrylate, 30 g of cyclohexyl methacrylate, 15 g of vinyltriethoxysilane, 8.0 g of LATEMUL S-180 (trade name, reactant emulsifier having unsaturated carbon, manufactured by Kao Corp., 100% by mass of ingredients), and 340 g of ion exchanged water were mixed, and then the obtained mixture was added dropwise over 3 hours. Thereafter, the resultant mixture was matured by heating at 80° C. for 2 hours, and then cooled to room temperature, and then the pH was adjusted to 7 to 8 by sodium hydroxide. Ethanol was distilled off using an evaporator, and a water content was adjusted, thereby preparing 730 g of aqueous dispersion of resin particles A having a solid content of 40 mass %.

### Production Example 4-1

Synthesis of Self-Dispersing Polymer B-1

In a 2 L three necked flask equipped with a stirrer, a thermometer, a reflux condenser tube, and a nitrogen gas introducing pipe, 540.0 g of methyl ethyl ketone was placed, and the temperature was increased to 75° C. While maintaining the temperature in the reactor at 75° C., a mixed solution containing 108 g of methyl methacrylate, 388.8 g of isobornyl methacrylate, 43.2 g of methacrylic acid, 108 g of methyl ethyl ketone, and 2.16 g of “V-601” (trade name, manufactured by Wako Pure Chemical Inc., Ltd.) was added dropwise to the reactor at a constant speed so that the dropwise addition was completed spending 2 hours. After the completion of the dropwise addition, a solution containing 1.08 g of “V-601” and 15.0 g of methyl ethyl ketone was added, and the resulting mixture was stirred at 75° C. for 2 hours. Thereafter, a solution containing 0.54 g of “V-601” and 15.0 g of methyl ethyl ketone was further added, and the resulting mixture was stirred at 75° C. for 2 hours. Thereafter, the temperature was increased to 85° C., and the mixture was continuously stirred for further 2 hours, thereby obtaining a resin solution of methyl methacrylate/isobornyl methacrylate/methacrylic acid (=20/72/8 [mass ratio]) copolymer.

The weight average molecular weight (Mw) of the obtained copolymer was 61,000 and the acid value thereof was 52.1 mgKOH/g. The weight average molecular weight was determined by gel permeation chromatography (GPC), and calculated in polystyrene equivalent. GPC was conducted using HLC-8020GPC (trade name, manufactured by TOSOH CORPORATION) equipped with TSK-GEL SUPER HZM-H, TSK-GEL SUPER HZ 4000 and TSK-GEL SUPER HZ 200 (trade names, manufactured by TOSOH CORPORATION) as columns, and THF (tetrahydrofuran) as an eluent. The acid value was determined according to a method described in JIS (JIS K0070: 1992).

Next, 588.2 g of the resin solution was weighed, 165 g of isopropanol and 120.8 ml of 1 mol/L aqueous NaOH solution were added, and the temperature in the reactor was increased to 80° C. Next, 718 g of distilled water was added dropwise at a rate of 20 ml/min for water dispersing. Thereafter, the content in the reactor was held under atmospheric pressure while maintaining the temperature in the reactor at 80° C. for 2 hours, at 85° C. for 2 hours, and then at 90° C. for 2 hours, and the solvent was distilled off. Further, the pressure in the reactor was reduced, and isopropanol, methyl ethyl ketone, and distilled water were distilled off, thereby obtaining an aqueous dispersion of self-dispersing polymer B-1 (resin particles) having a solid content concentration of 26.0% by mass.

### Production Examples 4-2 to 4-5

### Preparation of Aqueous Dispersions of Resin Particles B-2 to B-5

Water dispersions of resin particles B-2 to B-5 were prepared in the same manner as in Production Example 4-1, except for changing the type and the ratio of monomers in Production Example 4-1 as follows.
B-2: Methyl methacrylate/Dicyclopentanyl methacrylate/Methacrylic acid (=40/50/10)

The obtained copolymer had a weight average molecular weight (Mw) of 55000 and an acid value of 65.1 mgKOH/g. The solid content of the aqueous dispersion was 25% by mass.
B-3: Methyl methacrylate/Dicyclopentanyl methacrylate/Methoxy polyethylene glycol methacrylate (n=2)/Methacrylic acid (54/35/5/6)

The obtained copolymer had a weight average molecular weight (Mw) of 60000 and an acid value of 39.1 mgKOH/g. The solid content of the aqueous dispersion was 25% by mass.
B-4: n-Butyl methacrylate/Cyclohexyl methacrylate/Styrene/Acrylic acid copolymer (30/55/10/5)

The obtained copolymer had a weight average molecular weight (Mw) of 58000 and an acid value of 38.9 mgKOH/g. The solid content of the aqueous dispersion was 25% by mass.
B-5: Phenoxyethyl acrylate/Methyl methacrylate/Acrylic acid copolymer (20/70/10)

The obtained copolymer had a weight average molecular weight (Mw) of 63000 and an acid value of 77.8 mgKOH/g. The solid content of the aqueous dispersion was 25% by mass.

The actual measurement values (measured Tg) of the glass transition temperature of the resin particles A and B-1 to B-5 are shown in Table 1. The measured Tg was measured by the following method.

A water dispersion of 0.5 g of resin particles in terms of solid content were vacuum dried at 50° C. for 4 hours, thereby obtaining a polymer solid. The Tg was measured using the obtained polymer solid by a differential scanning calorimeter (DSC) EXSTAR6220 (trade name, manufactured by SII Nanotechnology Inc). As the measurement conditions, 5 mg of sample was sealed in an aluminum pan, and the value of the peak top of DDSC of the measurement data in the second temperature elevation with the following temperature profiles under a nitrogen atmosphere was defined as the measured Tg.
30° C.→−50° C. (cooling at 50° C./m)
−50° C.→120° C. (temperature elevation at 20° C./m)
120° C.→−50° C. (cooling at 50° C./m)
50° C.→120° C. (temperature elevation at 20° C./m)

TABLE 1

| | Measured Tg (° C.) |
|---|---|
| Resin particles A | −15 |
| Resin particles B-1 | 180 |
| Resin particles B-2 | 130 |
| Resin particles B-3 | 100 |
| Resin particles B-4 | 86 |
| Resin particles B-5 | 71 |

### Production Example 5

### Preparation of Inks 1 to 22

Cyan color inks 1 to 12, 17, 18, and 22, magenta color inks 13 and 19, yellow color inks 14 and 20, and black color inks 15 and 21 each were prepared using the pigment dispersions C-1, M-1, Y-1, and K-1 and the water dispersions of the resin particles A and B-1 to B-5 obtained in the Production Examples above in such a manner as to have the composition shown in Tables 2-1 and 2-2. Separately, a cyan color ink 16 was prepared using a DIRECT BLUE 199 (trade name, manufactured Daiwa Fine Chemicals Co., Ltd.) in such a manner as to have the composition shown in Table 2-2. In this case, the surface tension, the solid ingredient content, and the liquid ingredient content of each ink are as shown in Tables 2-1 and 2-2. In Tables 2-1 and 2-2, OLFINE E-1010 (trade name, manufactured by Nisshin Chemical Co., Ltd.) is an acetylene glycol surfactant and FS-300 (trade name, manufactured by DuPont) is a fluorine surfactant.

TABLE 2-1

| | Ink 1 | Ink 2 | Ink 3 | Ink 4 | Ink 5 | Ink 6 | Ink 7 | Ink 8 | Ink 9 | Ink 10 | Ink 11 |
|---|---|---|---|---|---|---|---|---|---|---|---|
| Cyan dye (Direct blue 199) | | | | | | | | | | | |
| Cyan pigment dispersion C-1 | 45.8% | 45.8% | 45.8% | 27.5% | 45.8% | 45.8% | 45.8% | 22.9% | 22.9% | 22.9% | 22.9% |
| Magenta pigment dispersion | | | | | | | | | | | |
| M-1 | | | | | | | | | | | |
| Yellow pigment dispersion Y-1 | | | | | | | | | | | |
| Black pigment dispersion K-1 | | | | | | | | | | | |
| Resin particles A | 10.0% | 10.0% | 10.0% | 36.0% | | | | | | | |
| Resin particles B-1 | | | | | 15.4% | 15.4% | 15.4% | 32.7% | | | |
| Resin particles B-2 | | | | | | | | | 32.7% | | |
| Resin particles B-3 | | | | | | | | | | 32.7% | |
| Resin particles B-4 | | | | | | | | | | | 32.7% |
| Resin particles B-5 | | | | | | | | | | | |
| Glycerol | 4.0% | 2.1% | 14.4% | 10.1% | 8.3% | 8.3% | 8.3% | 8.3% | 8.3% | 8.3% | 8.3% |
| 1,3-butanediol | | 6.2% | | | | | | | | | |
| Thiodiglycol | | | | | | | | | | | |
| Urea | | | | | | | | | | | |
| 2-ethyl-1,3-hexanedial | 2.0% | 2.0% | 2.0% | 2.0% | 2.0% | 2.0% | 2.0% | 2.0% | 2.0% | 2.0% | 2.0% |
| Olefin E-1010 | 1.0% | 1.0% | 1.0% | 1.0% | 2.0% | 4.0% | 1.0% | 1.0% | 1.0% | 1.0% | 1.0% |
| FS-300 | | | | | | | | | | | |
| Triethanolamine | 0.3% | 0.3% | 0.3% | 0.3% | 0.3% | 0.3% | 0.3% | 0.3% | 0.3% | 0.3% | 0.3% |
| Water | 36.9% | 32.6% | 26.5% | 23.1% | 26.2% | 24.2% | 27.2% | 32.8% | 32.8% | 32.8% | 32.8% |
| Total | 100% | 100% | 100% | 100% | 100% | 100% | 100% | 100% | 100% | 100% | 100% |
| Surface tension | 35.1 | 35.2 | 35.5 | 35.2 | 32.3 | 30.5 | 35.1 | 35.2 | 35.5 | 35.4 | 35.2 |
| Solid ingredient content (B) | 12.4% | 12.4% | 12.4% | 19.5% | 12.4% | 12.4% | 12.4% | 12.7% | 12.7% | 12.7% | 12.7% |
| Liquid ingredient content (A) | 11.4% | 15.7% | 21.9% | 15.9% | 16.7% | 18.7% | 15.7% | 13.6% | 13.6% | 13.6% | 13.6% |
| A/B | 0.92 | 1.27 | 1.76 | 0.85 | 1.35 | 1.51 | 1.27 | 1.07 | 1.07 | 1.07 | 1.07 |

TABLE 2-2
Continued from Table 2-1

| | Ink 12 | Ink 13 | Ink 14 | Ink 15 | Ink 16 | Ink 17 | Ink 18 | Ink 19 | Ink 20 | Ink 21 | Ink 22 |
|---|---|---|---|---|---|---|---|---|---|---|---|
| Cyan dye (Direct blue 199) | | | | | 4.0% | | | | | | |
| Cyan pigment dispersion C-1 | 22.9% | | | | | 45.8% | 45.8% | | | | 45.8% |
| Magenta pigment dispersion | | 45.9% | | | | | | 39.1% | | | |
| M-1 | | | | | | | | | | | |
| Yellow pigment dispersion Y-1 | | | 27.5% | | | | | | 30.6% | | |
| Black pigment dispersion K-1 | | | | 36.7% | | | | | | 40.0% | |
| Resin particles A | | | | | | 10.0% | | 16.0% | 20.0% | 13.8% | |
| Resin particles B-1 | | 26.9% | 26.9% | 19.2% | | | | | | | 15.4% |
| Resin particles B-2 | | | | | | | | | | | |
| Resin particles B-3 | | | | | | | | | | | |
| Resin particles B-4 | | | | | | | | | | | |
| Resin particles B-5 | 32.7% | | | | | | | | | | |
| Glycerol | 8.3% | 8.3% | 9.8% | 12.3% | 7.0% | 4.0% | 4.0% | 9.9% | 10.8% | 135% | 8.3% |
| 1,3-butanediol | | | | | | | | 4.5% | 4.5% | 4.5% | |
| Thiodiglycol | | | | | 7.0% | | | | | | |
| Urea | | | | | 7.0% | | | | | | |
| 2-ethyl-1,3-hexanedial | 2.0% | 2.0% | 2.0% | 2.0% | | 2.0% | 2.0% | 2.0% | 2.0% | 2.0% | 2.0% |
| Olefin E-1010 | 1.0% | 1.0% | 1.0% | 1.0% | 1.5% | | 1.0% | | | | |
| FS-300 | | | | | | 2.5% | | 2.5% | 2.5% | 2.5% | |
| Triethanolamine | 0.3% | 0.3% | 0.3% | 0.3% | | 0.3% | 0.3% | 0.3% | 0.3% | 0.3% | 0.3% |
| Water | 32.8% | 15.6% | 32.5% | 28.5% | 73.5% | 35.4% | 46.9% | 25.7% | 29.3% | 23.4% | 28.2% |
| Total | 100% | 100% | 100% | 100% | 100% | 100% | 100% | 100% | 100% | 100% | 100% |
| Surface tension | 35.0 | 35.3 | 36.0 | 34.7 | 35.4 | 25.0 | 25.2 | 23.7 | 24.3 | 24.3 | 42.1 |
| Solid ingredient content (B) | 12.7% | 15.4% | 12.1% | 12.3% | — | 12.4% | 8.4% | 13.6% | 13.6% | 13.5% | 12.4% |
| Liquid ingredient content (A) | 13.6% | 15.4% | 15.3% | 15.3% | 22.5% | 11.1% | 11.1% | 21.0% | 20.2% | 20.0% | 14.7% |
| A/B | 1.07 | 1.00 | 1.27 | 1.24 | — | 0.90 | 1.32 | 1.54 | 1.48 | 1.48 | 1.18 |

### Image Formation Example 1

Image formation was performed under the following conditions using the cyan color inks 1 to 12, 16 to 18, and 22 obtained in Production Example 5 above. Thereafter, the obtained record images were evaluated as follows. The results are shown in Table 3.

Image Formation

OK TOPCOAT+ (trade name, manufactured by Oji Paper Co., Ltd., Basis weight of 104.7 g/m², Transfer amount of pure water in a recording medium measured by a dynamic scanning absorptometer: 3.0 ml/m² at a contact time of 100 ms and 3.4 ml/m² at a contact time of 400 ms) was prepared as a recording medium (coated paper) and a recording device having the structure shown in FIG. 1 was prepared as an ink jet recording device. The recording device was started, the recording medium was fixed on a hard rubber belt thereof and conveyed at a conveyance rate of 400 mm/sec, and then images were formed by the processes described below. In FIG. 1, <III> corresponds to the following process 1, <IV> corresponds to the following process 2, and <V> corresponds to the following process 3, respectively.

### 1. Image Recording Step

Two GELJET GX5000 printer heads (trade name, full line head manufactured by Ricoh Co., Ltd.) were arranged and fixed so that the direction of the line head (main scanning direction) in which nozzles are disposed inclined at 75.7° relative to the direction orthogonal to the running direction (sub-scanning direction) of an endless hard rubber belt as illustrated in FIG. 1. In a first ink jet head 31 and a second ink jet head 32, the cyan ink obtained above was charged. Then, the position of each of the first ink jet head and the second ink jet head was adjusted so that the ink droplets ejected from each of the heads were overlapped. Thereafter, each ink was ejected by an ink jet method under the following conditions to the surface to be coated of the recording medium, and an image for evaluation with respect to each evaluation item was recorded.

Conditions
Amount of ejected ink droplet: 2.4 pL
Resolution: 1200 dpi×1200 dpi

### 2. Ink Drying Step

Subsequently, the recording medium was conveyed by a belt to a dry region, and then the recording medium to which the ink droplets were applied was dried under the following conditions by blowing air with a drying fan 41 while being heated with a contact type plate heater 42 via the belt from the rear side (opposite side of the recorded surface) of the recording medium. Here, the moisture content in the recording medium on which images were recorded was determined immediately after the drying step, and the moisture content quantitatively determined by Karl Fischer coulometric titration method using a moisture meter CA-200 (trade name, manufactured by Mitsubishi Chemical Analytech, Co., Ltd.) was from about 2.0 g/m² to about 3.0 g/m².

Conditions

Drying method: blast drying

Air speed: 15 m/s

Temperature: The recording medium was heated so that the surface temperature on the recorded surface side of the recording medium became 60° C.

### 3. Fixing Step

Next, the recording medium was passed between a pair of rollers (a silicone rubber roller 51 and a large diameter drum 52) that were pressed against each other under the following conditions to thereby subjecting the images to thermal fixing treatment, and then piled up in a collection tray (not illustrated) and collected as it was. To the surface of the silicone rubber roller 51, silicone oil was thinly applied for preventing adhesion.

Conditions

Silicone rubber roller 51: Hardness of 50°, Nip width of 5 mm

Surface temperature of silicone rubber roller 51: each fixing temperature shown in Table 3

Surface temperature of drum 52: 60° C.

Pressure: 0.2 MPa

Evaluation

Water Resistance

Images containing a character image of the kanji for boom, “todoroki” of 10 pt formed by the ink ejected from the first ink-jet head 31 and a white reverse character image of the kanji for boom, “todoroki” of 10 pt formed in a solid image formed by the ink ejected from the first ink-jet head 31 were formed. Then, 0.1 mg of pure water was added dropwise on each character, and the images were allowed to stand as they were and dried. Bleeding of the character was visually observed and evaluated in accordance with the following evaluation criteria.

Evaluation Criteria
A: No bleeding of image is observed.
B: A slight bleeding of image is observed partly. Practically non-problematic level.
C: Occurrence of bleeding of image is significant. Very low level with respect to practical application.

Offset Resistance

A solid image was formed by superposing the solid image formed by the inks ejected from the second ink jet head 32 on the solid image formed by the inks ejected from the first ink jet head 31. Then, stain of each of the image surface and the silicone rubber roller was visually observed, and was evaluated in accordance with the following evaluation criteria.

Evaluation Criteria
A: No offset is observed.
B: A slight offset is observed partly. Practically non-problematic level.
C: Offset occurs. Minimum tolerable level for practical application.
D: Occurrence of offset is significant. Very low level with respect to practical application.

Image Resolution

Images containing a character image of the kanji for boom, “todoroki” of 5 pt to 10 pt formed by the ink ejected from the first ink-jet head 31 and a white reverse character image of the kanji for boom, “todoroki” of 10 pt formed in a solid image formed by the ink ejected from the first ink jet head 31 were formed. Then, the resolution was visually observed, and evaluated in accordance with the following evaluation criteria.

Evaluation Criteria
A: The resolution is excellent even with respect to the characters of 5 pt. Practically non-problematic level.
B: A reduction in the resolution is recognized in some characters of 5 pt. Practically non-problematic level.
C: A reduction in the resolution is recognized even in the characters of more than 5 pt. Low level with respect to practical application.
D: The characters are crushed, and a reduction in the resolution is significant. Very low level with respect to practical application.

Scratch Resistance

A recording medium to which a solid image was recorded by the ink ejected from the first ink jet head 31 was left to stand for 24 hours under conditions of a temperature of 25° C. and a humidity of 60% RH. Thereafter, an unrecorded recording medium (the same recording medium as that used for recording (hereinafter, referred to as an unused sample in regard to the current evaluation)) was placed on the solid image, and was rubbed back and forth 10 times with a load of 150 kg/m². The degree of transfer of ink to the blank (white background) area of the unused sample was visually observed, and was evaluated according to the following evaluation criteria.

Evaluation Criteria
A: There is no transfer of ink at all.
B: Transfer of ink is hardly noticeable.
C: Some level of transfer of ink is observed.
D: Transfer of ink is significant.

Blocking Resistance

Immediately after recording a solid image by the ink ejected from the first ink jet head 31, an unrecorded recording medium (the same recording medium as that used for recording (hereinafter, referred to as an unused sample in regard to the current evaluation)) was placed on the solid image, and was left for 6 hours under conditions of a temperature of 60° C. and a humidity of 30% RH with a load of 350 kg/m². The degree of transfer of ink to the blank area of the unused sample was visually observed, and was evaluated according to the following evaluation criteria.

Evaluation Criteria
A: There is no transfer of ink at all.
B: Transfer of ink is hardly noticeable.
C: Some level of transfer of ink is observed. Minimum tolerable level for practical application.
D: Transfer of ink is significant.

TABLE 3

| | Examples | | | | | | | | |
|---|---|---|---|---|---|---|---|---|---|
| | Ink 1 | Ink 1 | Ink 2 | Ink 3 | Ink 4 | Ink 5 | Ink 6 | Ink 7 | Ink 8 |
| Surface | 35.1 | 35.1 | 35.2 | 35.5 | 35.2 | 32.3 | 30.5 | 35.1 | 35.2 |
| tension | | | | | | | | | |
| Measured Tg | −15 | −15 | −15 | −15 | −15 | 180 | 180 | 180 | 180 |
| of resin | | | | | | | | | |
| particles (° C.) | | | | | | | | | |
| Liquid/ | 0.92 | 0.92 | 1.27 | 1.76 | 0.82 | 1.35 | 1.51 | 1.27 | 1.07 |
| Solid ratio | | | | | | | | | |
| (A/B) | | | | | | | | | |
| Fixing | 80° C. | 140° C. | 80° C. | 80° C. | 80° C. | 80° C. | 80° C. | 95° C. | 95° C. |
| temperature | | | | | | | | | |
| Water | A | A | A | A | A | A | A | A | A |
| resistance | | | | | | | | | |
| Offset | B | C | B | B | B | A | A | A | A |
| resistance | | | | | | | | | |
| Image | A | A | A | A | A | A | B | A | A |
| resolution | | | | | | | | | |
| Scratch | A | A | A | A | A | A | A | A | A |
| resistance | | | | | | | | | |
| Blocking | B | C | B | C | C | A | A | A | A |
| resistance | | | | | | | | | |

| | Comparative Examples | | | | | | | |
|---|---|---|---|---|---|---|---|---|
| | Ink 9 | Ink 10 | Ink 11 | Ink 12 | Ink 16 | Ink 17 | Ink 18 | Ink 22 |
| Surface | 35.5 | 35.4 | 35.2 | 35.0 | 35.4 | 25.0 | 25.2 | 42.1 |
| tension | | | | | | | | |
| Measured Tg | 130 | 100 | 86 | 71 | — | −15 | — | 180 |
| of resin | | | | | | | | |
| particles (° C.) | | | | | | | | |
| Liquid/ | 1.07 | 1.07 | 1.07 | 1.07 | — | 0.90 | 1.32 | 1.18 |
| Solid ratio | | | | | | | | |
| (A/B) | | | | | | | | |
| Fixing | 90° C. | 80° C. | 80° C. | 80° C. | 140° C. | 140° C. | 140° C. | 95° C. |
| temperature | | | | | | | | |
| Water | A | A | A | A | C | A | A | A |
| resistance | | | | | | | | |
| Offset | A | A | A | B | B | C | D | A |
| resistance | | | | | | | | |
| Image | A | A | A | A | B | C | D | C |
| resolution | | | | | | | | |
| Scratch | A | A | A | A | D | A | D | A |
| resistance | | | | | | | | |
| Blocking | A | A | A | A | B | C | B | A |
| resistance | | | | | | | | |

As shown in Table 3, in the Examples, images having each excellent water resistance, image resolution, and scratch resistance were obtained. The offset resistance and the blocking resistance were equal to or higher than a tolerable level for practical application in the Examples, and these properties are excellent especially in the Examples in which the glass transition temperature of resin particles is high.

### Image Formation Example 2

A combination of the cyan color ink 8, the magenta color ink 13, the yellow color ink 14, and the black color ink 15 obtained in Production Example 5 above were defined as an ink set A. A combination of the cyan color ink 18, the magenta color ink 19, the yellow color ink 20, and the black color ink 21 obtained in Production Example 5 above were defined as an ink set H.

Image formation was performed in the same manner as in the image formation example 1, except charging the ink sets A and H in the first ink jet head 31 and the second ink jet head 32 and changing the recording medium to recording media shown in Tables 4 and 5 in the image formation example 1, and the obtained recorded images were evaluated. The results are shown in Tables 4 and 5. In Tables 4 and 5, the transfer amount of pure water (ml/m²) refers to a transfer amount of pure water to the recording media measured by a dynamic scanning absorptometer at a contact time of 100 ms or a contact time of 400 ms.

TABLE 4

| | | | | | Transfer | | | | |
|---|---|---|---|---|---|---|---|---|---|
| | | | | | amount of | | | | |
| | | | | Basis | pure water | | Ink set A | | |
| | | | | weight | (ml/m²) | | Offset | Image | Blocking |
| | | Grade | Manufacturer | (g/m²) | 100 ms | 400 ms | resistance | resolution | resistance |
| Ex. | OK TOP COAT+ | A2 | Oji paper | 104.7 | 3.0 | 3.4 | A | A | A |
| | | gloss | | | | | | | |
| Ex. | AURORA COAT | A2 | Nippon Paper | 104.7 | 2.8 | 3.4 | A | A | A |
| | | gloss | Group | | | | | | |
| Ex. | NEW AGE | A2 | Oji paper | 104.7 | 5.9 | 8.9 | A | A | A |
| | | matte | | | | | | | |
| Ex. | U-LIGHT | A2 | Nippon Paper | 104.7 | 3.9 | 5.9 | A | A | A |
| | | matte | Group | | | | | | |
| Ex. | TOKUBISHI | A1 art | Mitsubishi Paper | 104.7 | 2.7 | 3.5 | B | A | B |
| | ART DOUBLE- | | Mills | | | | | | |
| | SIDED N | | | | | | | | |
| Ex. | OK KINFUJI+ | A1 art | Oji paper | 127 | 1.9 | 2.5 | B | A | B |
| Ex. | SA KINFUJI+ | A0 art | Oji paper | 127 | 1.9 | 2.2 | B | A | B |
| Comp. | MIRROR COAT | Cast | Oji paper | 104.7 | 0.2 | 0.3 | D | C | D |
| Ex. | PLATINUM | coat | | | | | | | |
| | | paper | | | | | | | |

TABLE 5

| | | | | | Transfer amount | | | | |
|---|---|---|---|---|---|---|---|---|---|
| | | | | Basis | of pure water | | Ink set H (Comparative Example) | | |
| | | | | weight | (ml/m²) | | | | Blocking |
| | | Grade | Maker | (g/m²) | 100 ms | 400 ms | Offset resistance | Image resolution | resistance |
| Comp. | OK TOP COAT+ | A2 gloss | Oji paper | 104.7 | 3.0 | 3.4 | C | C | C |
| Ex. | | | | | | | | | |
| Comp. | AURORA COAT | A2 gloss | Nippon Paper | 104.7 | 2.8 | 3.4 | C | C | C |
| Ex. | | | Group | | | | | | |
| Comp. | NEW AGE | A2 matte | Oji paper | 104.7 | 5.9 | 8.9 | C | C | C |
| Ex. | | | | | | | | | |
| Comp. | U-LIGHT | A2 matte | Nippon Paper | 104.7 | 3.9 | 5.9 | C | C | C |
| Ex. | | | Group | | | | | | |
| Comp. | TOKUBISHI ART | A1 art | Mitsubishi | 104.7 | 2.7 | 3.5 | D | D | D |
| Comp. | DOUBLE- | | Paper Mills | | | | | | |
| Ex. | SIDED N | | | | | | | | |
| Comp. | OK KINFUJI+ | A1 art | Oji paper | 127 | 1.9 | 2.5 | D | D | D |
| Ex. | | | | | | | | | |
| Comp. | SA KINFUJI+ | A0 art | Oji paper | 127 | 1.9 | 2.2 | D | D | D |
| Ex. | | | | | | | | | |
| Comp. | MIRROR COAT | Cast coat | Oji paper | 104.7 | 0.2 | 0.3 | D | D | D |
| Ex. | PLATINUM | paper | | | | | | | |

As shown in Tables 4 and 5, images exhibiting excellent image resolution were obtained in the Examples, and the offset resistance and the blocking resistance were equal to or higher than a level of causing no problems for practical application.

What is claimed is:

1. An image forming method comprising: at least
recording an image by ejecting, by an ink jet method, an ink composition containing, at least one pigment as a coloring material, particles of at least one resin, at least one water-soluble organic solvent, and water, the ink composition having a surface tension of from 30 mN/m to 40 mN/m, to a recording medium having a single-layered or multi-layered pigment layer on or above at least one side of a support containing cellulose pulp as a main ingredient and a transferring amount of pure water to the recording medium, when measured by a dynamic scanning liquid absorptometer, of from 1 ml/m² to 15 ml/m² at a period of contact time of 100 ms and from 2 ml/m² to 20 ml/m² at a period of contact time of 400 ms, and
heating the recorded image.

2. The image forming method according to claim 1, wherein a glass transition temperature of the resin particles is 80° C. or more.

3. The image forming method according to claim 1, wherein the heating of the recorded image is at least one of drying of an image in a state where a heat source and the recording medium are not in contact with each other, or fixing of the image in a state where the heat source and the recording medium are in contact with each other.

4. The image forming method according to claim 3, wherein a fixing temperature used in the fixing is lower than 100° C.

5. The image forming method according to claim 1, wherein the recording medium is a coated paper, a light weight coated paper, or a fine coated paper.

6. The image forming method according to claim 1, wherein the ink composition contains an acetylene glycol surfactant as a surface tension controlling agent.

7. The image forming method according to claim 1, wherein the ink composition comprises solid ingredients that are in a solid state in the ink composition of 25° C. and liquid ingredients that have a vapor pressure lower than that of water and are in a liquid state in the ink composition of 25° C., the total content of the solid ingredients in the ink composition is 2.0 mass % or more and lower than 20 mass %, and a ratio (A/B) of the total content (A) of liquid ingredients in the ink composition to the total content (B) of solid ingredients in the ink composition is from 0.70 to 1.75.

8. The image forming method according to claim 7, wherein the ratio A/B is in the range of 1.00 to 1.70.

9. The image forming method according to claim 7, wherein the ratio A/B is in the range of 1.20 to 1.65.

10. The image forming method according to claim 1, wherein the transfer amount of pure water to the recording medium, when measured by a dynamic scanning liquid absorptometer, of from 1 ml/m² to 10 ml/m² at a period of contact time of 100 ms and from 2 ml/m² to 15 ml/m² at a period of contact time of 400 ms.

11. The image forming method according to claim 1, wherein the transfer amount of pure water to the recording medium, when measured by a dynamic scanning liquid absorptometer, of from 1 ml/m² to 8 ml/m² at a period of contact time of 100 ms and from 2 ml/m² to 10 ml/m² at a period of contact time of 400 ms.

12. The image forming method according to claim 1, wherein the pigment is a self-dispersible pigment.

13. The image forming method according to claim 12, wherein the self-dispersible pigment is an anionically charged pigment or a cationically charged pigment.

14. The image forming method according to claim 13, wherein the self-dispersible pigment has an anionic hydrophilic group selected from the group consisting of —COOM, —SO₃M, —PO₃HM, —PO₃M₂, —SO₂NH₂, and —SO₂NHCOR, in which M represents a hydrogen atom, an alkaline metal, ammonium, or organic ammonium; and R represents an alkyl group having 1 to 12 carbon atoms, a phenyl group that may have a substituent, or a naphthyl group that may have a substituent.

15. The image forming method according to claim 13, wherein the self-dispersible pigment has an ammonium group.

16. The image forming method according to claim 12, wherein the self-dispersible pigment is used together with a polymer dispersant.

17. The image forming method according to claim 16, wherein the polymer dispersant has a carboxyl group.

18. The image forming method according to claim 1, wherein the surface tension of the ink composition is in the range of 32 mN/m to 40 mN/m.

19. The image forming method according to claim 1, wherein the surface tension of the ink composition is in the range of 32 mN/m to 38 mN/m.

20. The image forming method according to claim 4, wherein a fixing temperature in the fixing is lower than 100° C., and the glass transition temperature of the resin particles in the ink composition is 100° C. or more.
